(19) United States
(12) Patent Application Publication
(10) Pub. No.: US 2023/0031160 A1
(43) Pub. Date: Feb. 2, 2023

(54) INFORMATION PROCESSING APPARATUS, INFORMATION PROCESSING METHOD, AND COMPUTER PROGRAM

(71) Applicant: Sony Group Corporation, Tokyo (JP)

(72) Inventors: Tatsushi NASHIDA, Tokyo (JP); Yoshiyuki KOBAYASHI, Tokyo (JP)

(73) Assignee: Sony Group Corporation, Tokyo (JP)

(21) Appl. No.: 17/786,529

(22) PCT Filed: Oct. 30, 2020
(86) PCT No.: PCT/JP2020/040967

§ 371 Date: Jun. 17, 2022

(30) Foreign Application Priority Data
Dec. 27, 2019 (JP) 2019-239271

(51) Int. Cl. H04N 21/442; H04N 21/466; H04N 21/431; G06F 3/01

(52) U.S. Cl. CPC H04N 21/44218; H04N 21/466; H04N 21/431; G06F 3/013

(57) ABSTRACT

An information processing apparatus that processes information on the basis of a gaze degree of a user who views content is provided.

An information processing apparatus includes: an estimation unit that estimates a gaze degree of a user who views content; an acquisition unit that acquires related information to content recommended to the user; and a control unit that controls a user interface that presents the related information on the basis of an estimation result of the gaze degree. The acquisition unit acquires the related information by using an artificial intelligence model that has learned a causal relationship between information on a user and content in which a user shows interest.

### TECHNICAL FIELD

The technology disclosed in the present description (hereinafter, present disclosure”) relates to an information processing apparatus and an information processing method that process information regarding content viewing, as well as a computer program.

### BACKGROUND ART

Television broadcasting service has become widespread for a long time. Currently, television receivers are widely used, and one or more television receivers are installed in each household. Recently, video distribution services of a broadcast type (push distribution type) using a network such as Internet Protocol TV (IPTV) and Over-The-Top (OTT), and pull distribution type such as video sharing services are also becoming popular.

Furthermore, recently, research and development have also been conducted on the technology for measuring a “viewing quality” indicating a gaze degree of a viewer to video content by combining the television receiver and a sensing technology (see, for example, Patent Document 1). There are various methods of use of the viewing quality. For example, it is possible to evaluate the effect of video content or advertisements on the basis of the measurement result of the viewing quality, and to recommend other content or a product to the viewer.

### CITATION LIST

### Patent Document

Patent Document 1: Japanese Patent Application Laid-Open No. 2015-220530
Patent Document 2: Japanese Patent Application Laid-Open No. 2015-92529
Patent Document 3: Japanese Patent No. 4915143
Patent Document 4: Japanese Patent Application Laid-Open No. 2019-66788
Patent Document 5: WO 2017/104320
Patent Document 6: Japanese Patent Application Laid-Open No. 2007-143010

### SUMMARY OF THE INVENTION

### Problems to be Solved by the Invention

An object of the present disclosure is to provide an information processing apparatus and an information processing method that process information on the basis of a gaze degree of a user who views content, as well as a computer program.

### Solutions to Problems

A first aspect of the present disclosure is

an information processing apparatus including:

an estimation unit that estimates a gaze degree of a user who views content;

an acquisition unit that acquires related information to content recommended to the user; and

a control unit that controls a user interface that presents the related information on the basis of an estimation result of the gaze degree.

The acquisition unit acquires the related information by using an artificial intelligence model that has learned a causal relationship between information on a user and content in which a user shows interest.

Information on the user includes sensor information regarding a state of the user including line-of-sight when the user views content. Alternatively, information on the user includes environment information regarding an environment when the user views content, and the acquisition unit estimates content matching the user in accordance with regional characteristics based on the environment information for each user.

Furthermore, a second aspect of the present disclosure is

an information processing method including:

an estimation step of estimating a gaze degree of a user who views content;

an acquisition step of acquiring related information to content recommended to the user; and

a control step of controlling a user interface that presents the related information on the basis of an estimation result of the gaze degree.

Furthermore, a third aspect of the present disclosure is

a computer program described in a computer-readable form to cause a computer to function as:

an estimation unit that estimates a gaze degree of a user who views content;

an acquisition unit that acquires related information to content recommended to the user;

a control unit that controls a user interface that presents the related information on the basis of an estimation result of the gaze degree.

The computer program according to the third aspect defines a computer program described in a computer-readable form so as to implement predetermined processing on a computer. In other words, when the computer program according to the claims of the present application is installed to a computer, a cooperative action is exerted on the computer, and similar actions and effects to those of the information processing apparatus according to the first aspect can be achieved.

### Effects of the Invention

According to the present disclosure, it is possible to provide an information processing apparatus and an information processing method that perform matching between a user who gets bored with the content being viewed and the content that the user should view next, as well as a computer program.

Note that the effects described in the present description are merely examples, and the effects brought by the present disclosure are not limited thereto. Furthermore, the present disclosure may further provide additional effects in addition to the effects described above.

Yet other objects, features, and advantages of the present disclosure will become apparent from a more detailed description based on embodiments as described later and the accompanying drawings.

### BRIEF DESCRIPTION OF DRAWINGS

FIG. 1 is a diagram showing a configuration example of a system for viewing video content.

FIG. 2 is a diagram showing a configuration example of a content reproduction apparatus 100.

FIG. 3 is a view showing a configuration example of a dome screen 300.

FIG. 4 is a view showing a configuration example of a dome screen 400.

FIG. 5 is a view showing a configuration example of a dome screen 500.

FIG. 6 is a diagram showing another configuration example of the content reproduction apparatus 100.

FIG. 7 is a diagram showing an installation example of direction equipment 110.

FIG. 8 is a diagram showing a configuration example of a sensor unit 109.

FIG. 9 is a diagram showing a functional configuration example for collecting reactions of a user who has shown interest in content in the content reproduction apparatus 100.

FIG. 10 is a diagram showing a functional configuration example of an artificial intelligence server 1000.

FIG. 11 is a diagram showing a functional configuration for presenting information on recommended content to a user in the content reproduction apparatus 100.

FIG. 12 is a diagram showing a screen transition example according to a change in gaze degree of a user to content being viewed.

FIG. 13 is a diagram showing a screen transition example according to a change in gaze degree of a user to content being viewed.

FIG. 14 is a diagram showing a screen transition example according to a change in gaze degree of a user to content being viewed.

FIG. 15 is a diagram showing a screen transition example according to a change in gaze degree of a user to content being viewed.

FIG. 16 is a diagram showing a screen transition example according to a change in gaze degree of a user to content being viewed.

FIG. 17 is a diagram showing a screen transition example according to a change in gaze degree of a user to content being viewed.

FIG. 18 is a diagram showing a functional configuration example of a content recommendation system 1800.

FIG. 19 is a diagram showing a functional configuration example for collecting reactions of a user who has shown interest in content in the content reproduction apparatus 100.

FIG. 20 is a diagram showing a functional configuration example of an artificial intelligence server 2000.

FIG. 21 is a diagram showing a functional configuration for presenting information on recommended content in accordance with regional characteristics to a user in the content reproduction apparatus 100.

FIG. 22 is a diagram showing a functional configuration example of a content recommendation system 2200.

FIG. 23 is a view showing a matching operation example of a user and content in accordance with regional characteristics.

FIG. 24 is a diagram showing a matching operation example of a user and content in accordance with regional characteristics.

FIG. 25 is a diagram showing a sequence example executed between the content reproduction apparatus 100 and the content recommendation system 1800.

FIG. 26 is a diagram showing a sequence example executed between the content reproduction apparatus 100 and the content recommendation system 2200.

### MODE FOR CARRYING OUT THE INVENTION

An embodiment of the present disclosure will be described below in detail with reference to the drawings.

A. System Configuration

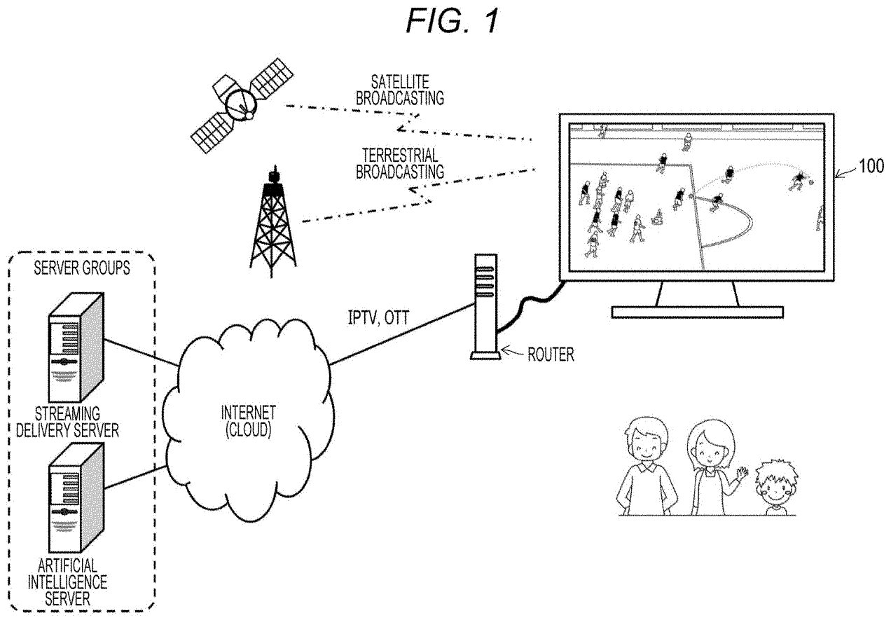

FIG. 1 schematically shows a configuration example of a system for viewing video content.

The content reproduction apparatus 100 is, for example, a television receiver installed in a living room where family members get together for pastime in household, a private room of a user, or the like. However, the content reproduction apparatus 100 is not necessarily limited to a stationary apparatus such as a television receiver, and may be a small or portable device such as a personal computer, a smartphone, a tablet, or a head-mounted display, for example. Furthermore, in the present embodiment, the term “user” simply refers to a viewer who views (including a case where the viewer has a plan to view) video content displayed on the content reproduction apparatus 100, unless otherwise specified.

The content reproduction apparatus 100 is equipped with a display that displays video content and a speaker that outputs sound. The content reproduction apparatus 100 includes, for example, a built-in tuner for selecting and receiving a broadcast signal, or is externally connected to a set-top box having a tuner function, and can use a broadcast service provided by a television station. The broadcast signal may be either a terrestrial wave or a satellite wave.

Furthermore, the content reproduction apparatus 100 can also use a video distribution service using a network such as IPTV, OTT, and a video sharing service. Therefore, the content reproduction apparatus 100 is equipped with a network interface card, and is interconnected to an external network such as the Internet via a router or an access point using communication based on an existing communication standard such as Ethernet (registered trademark) or Wi-Fi (registered trademark). In the functional aspect, the content reproduction apparatus 100 is also a content acquisition apparatus, a content reproduction apparatus, or a display apparatus equipped with a display having a function of acquiring or reproducing various types of content to be presented to the user by acquiring various types of reproduction content such as video and audio by streaming or downloading via a broadcast wave or the Internet.

A streaming delivery server that gives video streaming is installed on the Internet, and provides a broadcast-type video distribution service to the content reproduction apparatus 100.

Furthermore, a countless number of servers providing various services are installed on the Internet. An example of the server is a streaming delivery server that provides a video streaming delivery service using a network such as IPTV, OTT, or a video sharing service. On the content reproduction apparatus 100 side, the browser function is activated to issue, for example, a hyper text transfer protocol (HTTP) request to a streaming delivery server, so that the streaming delivery service can be used.

Furthermore, in the present embodiment, there is also assumed an artificial intelligence server that provides a function of artificial intelligence on the Internet (alternatively, on the cloud) to a client. The artificial intelligence is a function that artificially realizes, by software or hardware, a function exhibited by a human brain, such as learning, inference, data creation, and planning, for example. The function of artificial intelligence can be realized using an artificial intelligence model represented by a neural network that simulates a human cranial nerve circuit.

The artificial intelligence model is a calculation model having variability used for artificial intelligence, which changes a model structure through learning (training) accompanied by input of learning data. In a case of a neural network that uses a neuromorphic (brain-type) computer, a node is also called an artificial neuron via a synapse (or simply “neuron”). A neural network has a network structure formed by coupling between nodes (neurons), and generally includes an input layer, a hidden layer, and an output layer. Learning of an artificial intelligence model represented by the neural network is performed through processing of changing the neural network by inputting data (learning data) to the neural network and learning the degree of coupling (hereinafter, also called “coupling weighting coefficient”) between nodes (neurons). Use of learned artificial intelligence model makes it possible to estimate an optimal solution (output) for a problem (input). The artificial intelligence model is treated as set data of coupling weighting coefficients between nodes (neurons), for example.

Here, the neural network can have various algorithms, forms, and structures according to purposes, such as a convolutional neural network (CNN), a recurrent neural network (RNN), a generative adversarial network, a variational autoencoder, a self-organizing feature map, and a spiking neural network (SNN), and these can be arbitrarily combined.

The artificial intelligence server applied to the present disclosure is assumed to be equipped with a multistage neural network capable of performing deep learning (DL). When deep learning is performed, the number of learning data and the number of nodes (neurons) become large. Therefore, it is considered appropriate to perform deep learning using a huge computer resource such as cloud.

The “artificial intelligence server” mentioned in the present description is not limited to a single server device, and may be, for example, a form of cloud, which provides cloud computing services to a user via another device, and outputs and provides a service result (product) to another device.

Furthermore, the “client” (hereinafter, also called terminal, sensor device, or edge device) mentioned in the present description is characterized at least by downloading an artificial intelligence model learned by an artificial intelligence server from the artificial intelligence server as a result of service by the artificial intelligence server, and performing processing such as inference and object detection using the downloaded artificial intelligence model, or performing processing such as inference and object detection by the artificial intelligence server receiving sensor data inferred using the artificial intelligence model as a result of service. The client may perform deep learning in cooperation with the artificial intelligence server by further including a learning function using a relatively small neural network.

Note that the above-described neuromorphic computer technology and other artificial intelligence technologies are not independent from each other, and can be used in cooperation with each other. For example, a representative technology in the neuromorphic computer is SNN (described above). Use of the SNN technology enables output data from an image sensor or the like to be used as data to be provided to input of deep learning in a form differentiated on a time axis on the basis of an input data series, for example. Therefore, in the present description, unless otherwise specified, a neural network is treated as a type of artificial intelligence technology using a neuromorphic computer technology.

B. Apparatus Configuration

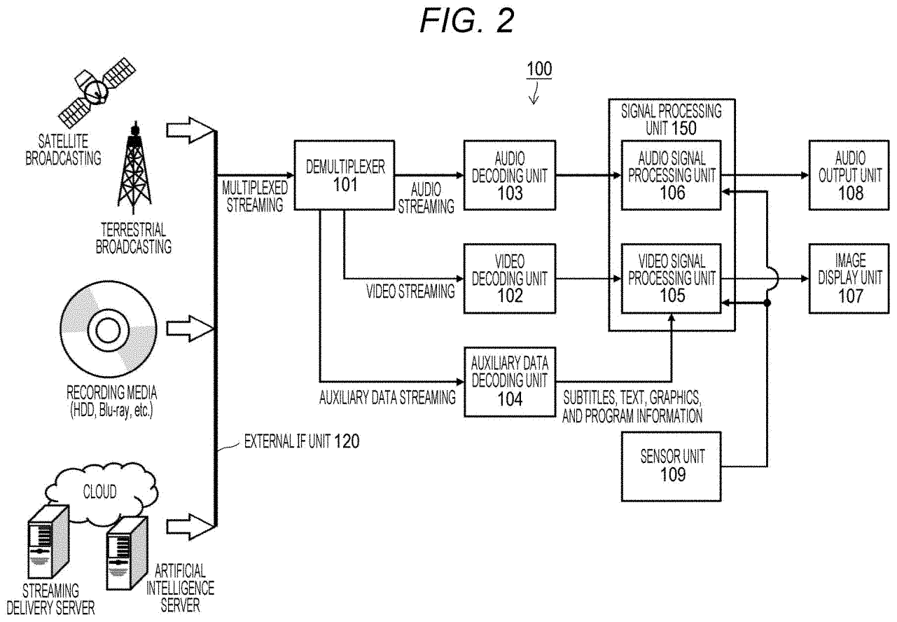

FIG. 2 shows a configuration example of the content reproduction apparatus 100. The content reproduction apparatus 100 in the figure includes an external interface unit 120 that performs data exchange with the outside, such as reception of content. The external interface unit 120 mentioned here is equipped with a High-Definition Multimedia Interface (HDMI) (registered trademark) interface for inputting a reproduction signal from a tuner that selects and receives a broadcast signal and a media reproduction apparatus, and a network interface (NIC) for connecting to a network. The external interface unit 120 has functions such as data reception from a medium such as broadcasting and cloud, and reading and retrieving data from the cloud.

The external interface unit 120 has a function of acquiring content provided to the content reproduction apparatus 100. The form in which content is provided to the content reproduction apparatus 100 is assumed to be a broadcast signal such as terrestrial broadcasting and satellite broadcasting, a reproduction signal reproduced from a recording medium such as a hard disk drive (HDD) or Blu-ray, streaming content delivered from a streaming delivery server on the cloud, or the like. Examples of the broadcast-type video distribution services using the network include IPTV, OTT, and video sharing services. Then, these pieces of content are supplied to the content reproduction apparatus 100 as a multiplexed bit stream obtained by multiplexing bit streams of media data such as video, audio, and auxiliary data (subtitles, text, graphics, program information, and the like). In the multiplexed bit stream, for example, it is assumed that data of each medium such as video and audio is multiplexed according to the MPEG2 system standard.

Note that the video stream provided from a broadcast station, a streaming delivery server, or a recording medium is assumed to include both 2D and 3D. The 3D video may be a free viewpoint video. The 2D video may include a plurality of videos imaged from a plurality of viewpoints. Furthermore, it is assumed that an audio stream provided from a broadcast station, a streaming delivery server, or a recording medium includes object-based audio (described later) in which individual sounding objects are not mixed.

Furthermore, in the present embodiment, it is assumed that the external interface unit 120 acquires an artificial intelligence model learned by deep learning or the like by an artificial intelligence server on the cloud. For example, the external interface unit 120 acquires an artificial intelligence model for video signal processing and an artificial intelligence model for audio signal processing.

The content reproduction apparatus 100 includes a demultiplexer 101, a video decoding unit 102, an audio decoding unit 103, an auxiliary data decoding unit 104, a video signal processing unit 105, an audio signal processing unit 106, an image display unit 107, and audio output unit 108. Note that the content reproduction apparatus 100 is a terminal apparatus such as a set-top box, and may be configured to process the received multiplexed bit stream and output processed video and audio signals to another device including the image display unit 107 and the audio output unit 108.

A demultiplexer 101 demultiplexes a multiplexed bit stream received from the outside as a broadcast signal, a reproduction signal, or streaming data into a video bit stream, an audio bit stream, and an auxiliary bit stream, and distributes the demultiplexed bit stream to each of the video decoding unit 102, the audio decoding unit 103, and the auxiliary data decoding unit 104 in the subsequent stage.

The video decoding unit 102 decodes, for example, an MPEG-encoded video bit stream, and outputs a baseband video signal. Note that it is also conceivable that the video signal output from the video decoding unit 102 is a low-resolution or standard-resolution video, or a low-dynamic range (LDR) or standard-dynamic range (SDR) video.

The audio decoding unit 103 decodes an audio bit stream encoded by the encoding system such as MPEG Audio Layer 3 (MP3) or High Efficiency MPEG4 Advanced Audio Coding (HE-AAC), and outputs a baseband audio signal. Note that the audio signal output from the audio decoding unit 103 is assumed to be a low-resolution or standard-resolution audio signal where a part of a band such as a high range is removed or compressed.

The auxiliary data decoding unit 104 decodes an encoded auxiliary bit stream and outputs subtitles, text, graphics, program information, and the like.

The content reproduction apparatus 100 includes a signal processing unit 150 that performs signal processing and the like of reproduction content. The signal processing unit 150 includes the video signal processing unit 105 and the audio signal processing unit 106.

The video signal processing unit 105 performs video signal processing on the video signal output from the video decoding unit 102 and the subtitle, text, graphics, program information, and the like output from the auxiliary data decoding unit 104. The video signal processing mentioned here may include image quality enhancement processing such as resolution conversion processing such as noise reduction and super-resolution, dynamic range conversion processing, and gamma processing. In a case where the video signal output from the video decoding unit 102 is a low-resolution or standard-resolution video or a low-dynamic range or standard-dynamic range video, the video signal processing unit 105 performs super-resolution processing of generating a high-resolution video signal from the low-resolution or standard-resolution video signal, and image quality enhancement processing such as high dynamic range. The video signal processing unit 105 may perform video signal processing after synthesizing the main video signal output from the video decoding unit 102 and the auxiliary data such as subtitles output from the auxiliary data decoding unit 104, or may perform synthesis processing after individually performing the image quality enhancement processing on the main video signal and the auxiliary data. In either case, the video signal processing unit 105 performs video signal processing such as super-resolution processing and high dynamic range within a range of a screen resolution or a luminance dynamic range allowed by the image display unit 107, which is an output destination of the video signal.

In the present embodiment, the video signal processing unit 105 is assumed to perform the video signal processing as described above by an artificial intelligence model. It is expected to realize the optimal video signal processing by using an artificial intelligence model in which an artificial intelligence server on the cloud has performed preliminary learning by deep learning.

The audio signal processing unit 106 performs audio signal processing on the audio signal output from the audio decoding unit 103. The audio signal output from the audio decoding unit 103 is a low-resolution or standard-resolution audio signal where a part of a band such as a high range is removed or compressed. The audio signal processing unit 106 may perform sound quality enhancement processing of performing band extension of a low-resolution or standard-resolution audio signal to a high-resolution audio signal including a removed or compressed band. Furthermore, the audio signal processing unit 106 performs processing of applying effects such as reflection, diffraction, and interference of the output sound. Furthermore, the audio signal processing unit 106 may perform sound image localization processing using a plurality of speakers in addition to the sound quality enhancement such as band extension. The sound image localization processing is implemented by determining the direction and the loudness of the sound at the position (hereinafter, also called “sounding coordinates”) of the sound image desired to localize and determining the combination of speakers for generating the sound image and the directivity and the volume of each speaker. Then, the audio signal processing unit 106 outputs an audio signal from each speaker.

Note that the audio signal treated in the present embodiment may be “object-based audio” in which individual sounding objects are supplied without being mixed and rendered on the reproduction equipment side. In object-based audio, data of an object audio includes meta information of a waveform signal with respect to a sounding object (object serving as sound source in video frame (may include object hidden from video)) and localization information of the sounding object represented by a relative position from a listening position serving as a predetermined reference. The waveform signal of the sounding object is rendered into an audio signal with a desired number of channels by, for example, vector based amplitude panning (VBAP) on the basis of the meta information, and is reproduced. The audio signal processing unit 106 can designate the position of the sounding object by using the audio signal conforming to object-based audio, and more robust stereophonic sound can be easily realized.

In the present embodiment, the audio signal processing unit 106 is assumed to perform the audio signal processing such as band extension, effects, and sound image localization by an artificial intelligence model. It is expected to realize the optimal audio signal processing by using an artificial intelligence model in which an artificial intelligence server on the cloud has performed preliminary learning by deep learning.

Furthermore, a single artificial intelligence model that performs video signal processing and audio signal processing in combination may be used in the signal processing unit 150. For example, in a case (described above) where processing such as object tracking, framing (including viewpoint switching and line-of-sight changing), and zooming is performed as video signal processing using an artificial intelligence model in the signal processing unit 150, the sound image position may be controlled in conjunction with a change in the position of the object in the frame.

The image display unit 107 presents the user (viewer of content or the like) a screen displaying a video on which video signal processing such as image quality enhancement has been performed by the video signal processing unit 105. The image display unit 107 is a display device including, for example, a liquid crystal display, an organic electro-luminescence (EL) display, a self-luminous display (see, for example, Patent Document 2) using fine light emitting diode (LED) elements for pixels, or the like.

Furthermore, the image display unit 107 may be a display device to which a partial drive technology of dividing a screen into a plurality of areas and controlling brightness for each area is applied. In the case of a display using a transmissive liquid crystal panel, luminance contrast can be improved by brightly lighting a backlight corresponding to an area with a high signal level and darkly lighting a backlight corresponding to an area with a low signal level. This type of partial drive type display device makes it possible to realize a high dynamic range by enhancing the luminance in a case where white display is partially performed (while the output power of the entire backlight is kept constant) by further utilizing a push-up technology in which power suppressed in a dark part is allocated to an area with a high signal level to intensively emit light (see, for example, Patent Document 3).

Alternatively, the image display unit 107 may be a 3D display or a display capable of switching between 2D video display and 3D video display. Furthermore, the 3D display may be a display having a screen capable of stereoscopically viewing, such as a naked-eye or glass-type 3D display, and a holographic display (or a light-field display) (see, for example, Patent Document 4) that enables different videos to be viewed according to the line-of-sight direction and has improved depth perception. Note that examples of the naked-eye 3D display include a display using a parallax barrier system, and multilayer display (MLD) that enhances a depth effect using a plurality of liquid crystal displays. In a case where a 3D display is used for the image display unit 107, the user can enjoy a stereoscopic video, so that a more effective viewing experience can be provided.

Alternatively, the image display unit 107 may be a projector (or a movie theater that projects video using a projector). A projection mapping technology of projecting a video onto a wall surface having an arbitrary shape or a projector stacking technology of superimposing projection videos from a plurality of projectors may be applied to the projector. Use of the projector makes it possible to enlarge and display video on a relatively large screen, and it therefore has an advantage that the same video can be simultaneously presented to a plurality of persons.

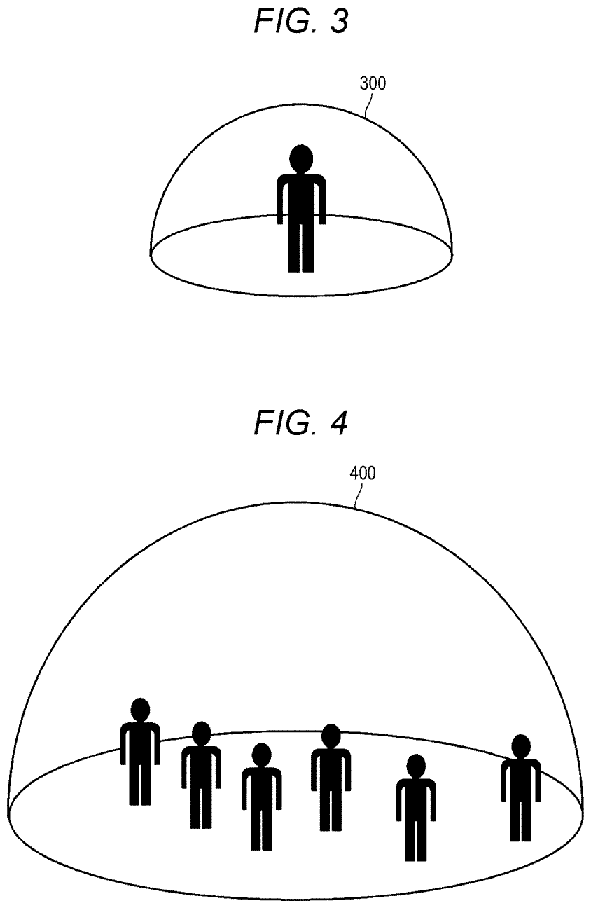

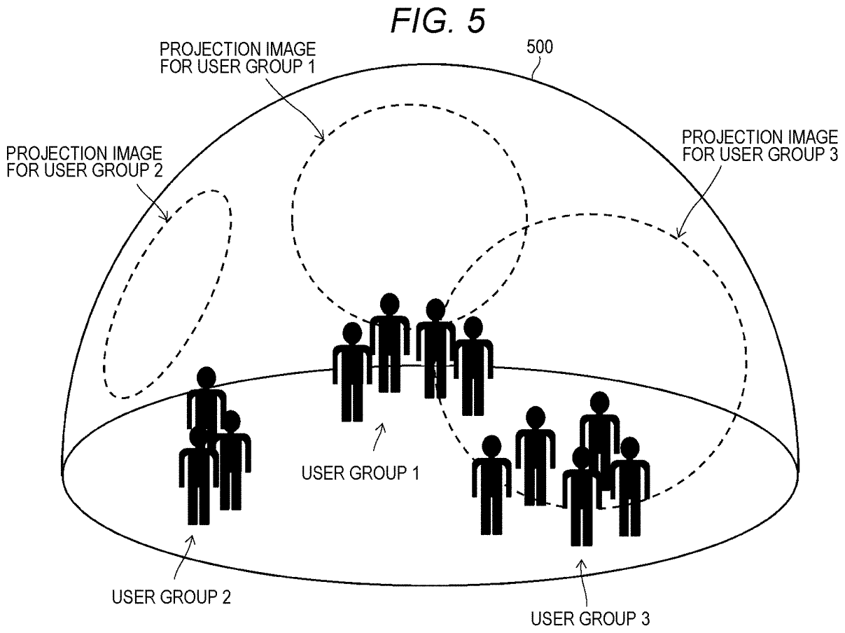

In a case where a projector is used for the image display unit 107, combining with a dome screen makes it possible to present an entire surrounding image to the user who is in the dome (see, for example, Patent Document 5). The dome screen may be the dome screen 300 having a compact size capable of accommodating only one user (see FIG. 3), or may be the dome screen 400 having a large scale capable of accommodating a plurality of or a large number of users (see FIG. 4). Furthermore, in a case where a plurality of groups of users is gathered in a lump in the large-scale dome screen 500 (see FIG. 5), instead of projecting one entire surrounding image onto the entire screen, content selected for each group of users or a user interface (UI) for each group of users may be projected and displayed in the vicinity of the group of users.

The explanation of the configuration of the content reproduction apparatus 100 goes on with reference to FIG. 2 again.

The audio output unit 108 outputs audio subjected to audio signal processing such as sound quality enhancement in the audio signal processing unit 106. The audio output unit 108 includes a sound generating element such as a speaker. For example, the audio output unit 108 may be a speaker array (multichannel speaker or super-multichannel speaker) in which a plurality of speakers is combined.

In addition to a conical speaker, a flat-panel speaker (see, for example, Patent Document 6) can be used for the audio output unit 108. Of course, a speaker array in which different types of speakers are combined can be used as the audio output unit 108. Furthermore, the speaker array may include one that performs audio output by vibrating the image display unit 107 by one or more vibration vibrators (actuators) that generate vibration. The vibrator (actuator) may be attached to the image display unit 107 afterwards.

Furthermore, some or all of the speakers constituting the audio output unit 108 may be externally connected to the content reproduction apparatus 100. The external speaker may have a form to be set down in front of the television such as a sound bar, or may have a form to be wirelessly connected to the television such as a wireless speaker. Furthermore, the speaker may be a speaker connected to another audio product via an amplifier or the like. Alternatively, the external speaker may be a smart speaker equipped with a speaker and capable of audio input, a wired or wireless headphone/headset, a tablet, a smartphone, a personal computer (PC), a so-called smart home appliance such as a refrigerator, a washing machine, an air conditioner, a vacuum cleaner, or a lighting fixture, or an Internet of Things (IoT) home appliance.

In a case where the audio output unit 108 includes a plurality of speakers, sound image localization can be performed by individually controlling audio signals output from each of a plurality of output channels. Furthermore, by increasing the number of channels and multiplexing speakers, it is possible to control a sound field with high resolution. For example, it is possible to generate a sound image at desired sounding coordinates by using a plurality of directional speakers in combination or annularly arranging a plurality of speakers, and adjusting the orientation and loudness of the sound emitted from each speaker.

The sensor unit 109 includes both a sensor equipped inside the main body of the content reproduction apparatus 100 and a sensor externally connected to the content reproduction apparatus 100. The externally connected sensor also includes a sensor built in other consumer electronics (CE) equipment or an IoT device existing in the space where the content reproduction apparatus 100 is present. In the present embodiment, it is assumed that the sensor information obtained from the sensor unit 109 becomes input information of a neural network used in the video signal processing unit 105 and the audio signal processing unit 106. However, details of the neural network will be described later.

C. Other Apparatus Configuration Examples

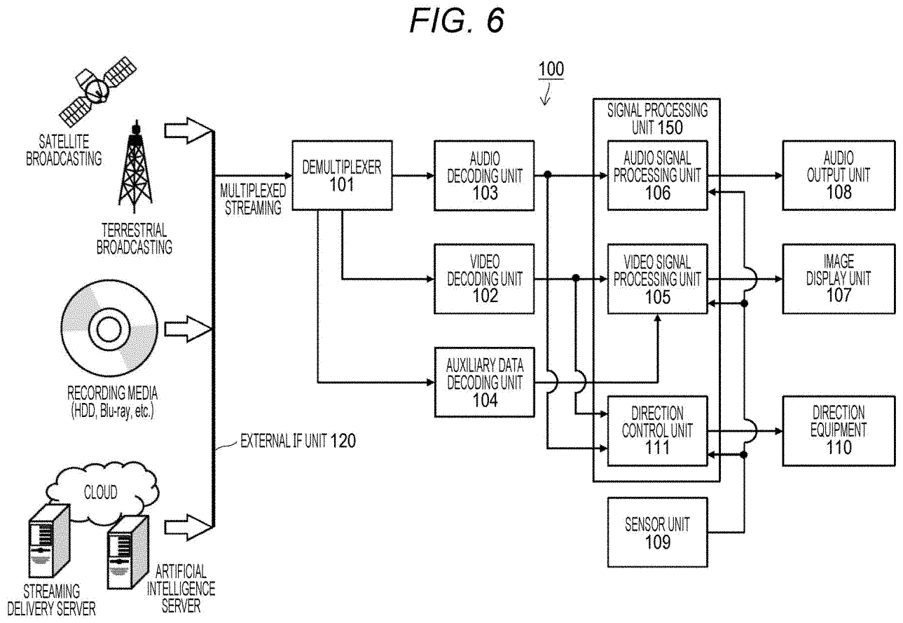

FIG. 6 shows another configuration example of the content reproduction apparatus 100. However, the same components as those shown in FIG. 2 are denoted by the same names and the same reference numerals, and the description will be omitted or the minimum description will be made.

The content reproduction apparatus 100 shown in FIG. 6 is characterized by being equipped with various types of direction equipment 110. The direction equipment 110 is equipment that stimulates the user's sense other than the video and sound of the content in order to enhance the realistic feeling of the user viewing the content being reproduced by the content reproduction apparatus 100. Therefore, by stimulating the sense of the user with other than the video and sound of the content in synchronization with the video and sound of the content that the user is viewing, the content reproduction apparatus 100 can enhance the realistic feeling of the user and perform the bodily sensation type direction.

It is assumed that the user's perception changes by the direction equipment 110 giving stimulation to the user. For example, in a scene where a creator desires to make the user feel a sense of fear at the time of creating content, the sense of fear of the user is provoked by giving a direction effect of sending cold air or blowing water droplets. The bodily sensation type direction technology, which is also called “4D”, has already been introduced in some movie theaters and the like, and stimulates the sense of the audience using movement of the seat back and forth, up and down, and left and right, wind (cold air, warm air), light (on/off of lighting and the like), water (mist, splash), scent, smoke, physical motion, and the like in conjunction with a scene being shown. On the other hand, in the present embodiment, it is assumed to use the direction equipment 110 that stimulates five senses of the user viewing the content being reproduced on the television receiver. Examples of the direction equipment 110 include an air conditioner, an electric fan, a heater, a lighting equipment (ceiling lighting, stand light, table lamp, and the like), a sprayer, a scent device, and a smoke machine. Furthermore, a wearable device, a handy device, an IoT device, an ultrasonic array speaker, an autonomous device such as a drone can be used for the direction equipment 110. The wearable device mentioned here includes a device such as a bracelet type or a neck type.

The direction equipment 110 may be a home appliance already installed in a room where the content reproduction apparatus 100 is installed, or may be dedicated equipment for giving stimulation to the user. Furthermore, the direction equipment 110 may be either external equipment externally connected to the content reproduction apparatus 100 or built-in equipment mounted in the housing of the content apparatus 100. The direction equipment 110 equipped as external equipment is connected to content reproduction apparatus 100 via a home network, for example.

The direction equipment 110 includes at least one of various types of direction equipment using wind, temperature, light, water (mist, splash), scent, smoke, physical motion, and the like. The direction equipment 110 is driven on the basis of a control signal output from a direction control unit 111 for each scene of the content (alternatively, in synchronization with video or audio). For example, in a case where the direction equipment 110 is direction equipment using wind, the wind speed, the wind volume, the wind pressure, the wind direction, the fluctuation, the temperature of the air blow, and the like are adjusted on the basis of a control signal output from the direction control unit 111.

In the example shown in FIG. 6, the direction control unit 111 is a component in the signal processing unit 150 similarly to the video signal processing unit 105 and the audio signal processing unit 106. A video signal and an audio signal, and sensor information output from the sensor unit 109 are input to the direction control unit 111. The direction control unit 111 outputs a control signal for controlling the driving of the direction equipment 110 so as to obtain a bodily sensation type direction effect suitable for each scene of the video and audio. In the example shown in FIG. 6, it is configured that video signals and audio signals after decoded are input to the direction control device 111, but it may be configured that video signals and audio signals before decoded are input to the direction control device 111.

In the present embodiment, it is assumed that the direction control unit 111 performs the drive control of the direction equipment 110 by an artificial intelligence model. It is expected to realize the optimal drive control of the direction equipment 110 by using an artificial intelligence model in which an artificial intelligence server on the cloud has performed preliminary learning by deep learning.

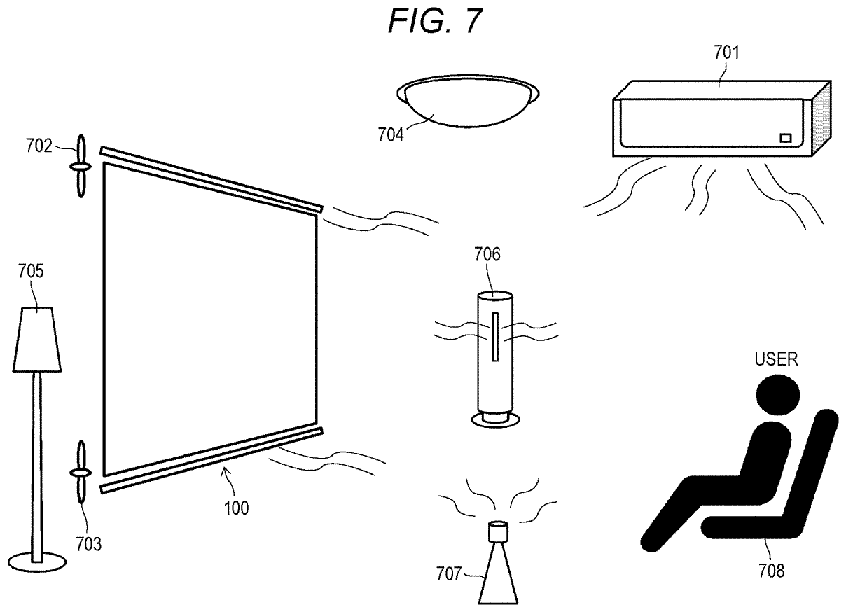

FIG. 7 shows an installation example of the direction equipment 110 in a room where a television receiver as the content reproduction apparatus 100 is present. In the example in the figure, the user is sitting in a chair, facing the screen of the television receiver.

In the room where the television receiver is installed, an air conditioner 701, fans 702 and 703 equipped in the television receiver, an electric fan (not illustrated), a heater (not illustrated), and the like are disposed as the direction equipment 110 that uses wind. In the example shown in FIG. 7, the fans 702 and 703 are arranged in the housing of the television receiver so as to blow air from the upper end edge and the lower end edge, respectively, of the large screen of the television receiver. Furthermore, the air conditioner 701, the fans 702 and 703, and the heater (not illustrated) can also operate as the direction equipment 110 that uses temperature. It is assumed that the user's perception changes by adjusting the wind speed, the wind volume, the wind pressure, the wind direction, the fluctuation, the temperature of the air blow, and the like of the fans 702 and 703.

Furthermore, lighting equipment such as ceiling lighting 704, stand light 705, and a table lamp (not illustrated) arranged in the room where the television receiver is installed can be used as the direction equipment 110 that uses light. It is assumed that the user's perception changes by adjusting the light amount of the lighting equipment, the light amount for each wavelength, the direction of the light beam, and the like.

Furthermore, a sprayer 706 that ejects mist or splash disposed in the room where the television receiver is installed can be used as the direction equipment 110 that uses water. It is assumed that the user's perception changes by adjusting the spray amount and the ejection direction of the sprayer 706, the particle diameter, the temperature, and the like.

Furthermore, in the room where the television receiver is installed, a scent device (diffuser) 707 that efficiently gives off a desired scent in a space by gas diffusion or the like is arranged as the direction equipment 110 that uses scent. It is assumed that the user's perception changes by adjusting the type, concentration, duration, and the like of the scent released by the scent device 707.

Furthermore, in the room where the television receiver is installed, a smoke machine (not illustrated) that ejects smoke into the air is arranged as the direction equipment 110 that uses smoke. A typical smoke machine instantaneously ejects liquefied carbon dioxide gas into the air to produce white smoke. It is assumed that the user's perception changes by adjusting the amount of smoke generated by the smoke machine, the concentration of smoke, the ejection time, the color of smoke, and the like.

Furthermore, a chair 708 installed in front of the screen of the television receiver and on which the user sits is capable of physical motion such as back and forth, up and down, and left and right movement, and vibration movement, and is used as the direction equipment 110 that uses motion. For example, a massage chair may be used as this type of the direction equipment 110. Furthermore, since the chair 708 is in close contact with the seated user, it is possible to obtain a direction effect by giving the user electrical stimulation to the extent without health hazard, or stimulating the user's cutaneous sensation (haptics) or tactile sensation.

The installation example of the direction equipment 110 shown in FIG. 7 is merely an example. In addition to those shown, a wearable device, a handy device, an IoT device, an ultrasonic array speaker, an autonomous device such as a drone can be used for the direction equipment 110. The wearable device mentioned here includes a device such as a bracelet type or a neck type. Furthermore, in a case where the image display unit 107 includes a dome screen (FIGS. 3 to 5), the direction equipment 110 may be installed in the dome. In a case where a plurality of groups of users is gathered in a lump in the large-scale dome screen 500 (see FIG. 5), content may be projected and displayed for each group of users, and the direction equipment 110 arranged for each group of users may be driven.

D. Sensing Function

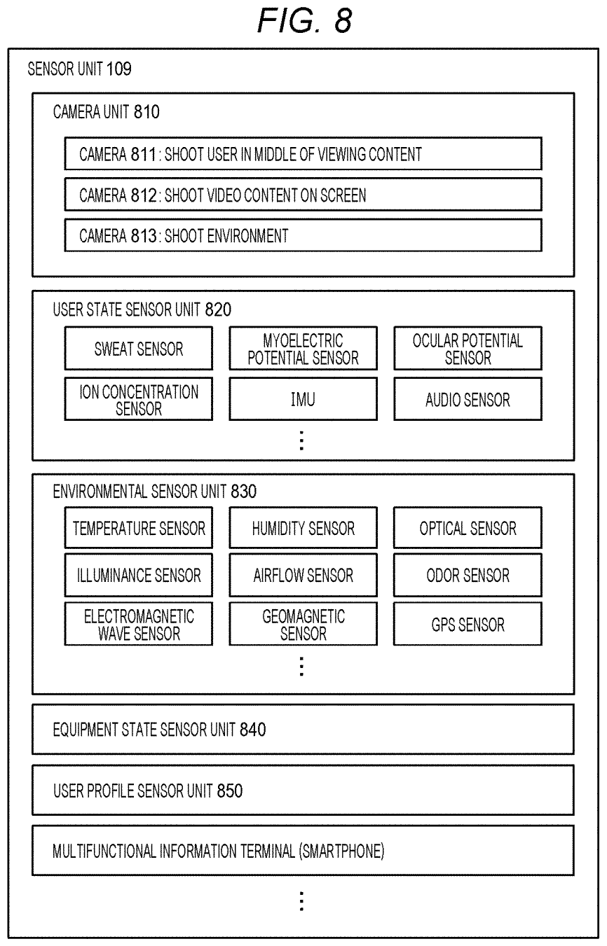

FIG. 8 schematically shows a configuration example of the sensor unit 109 equipped in the content reproduction apparatus 100. The sensor unit 109 includes a camera unit 810, a user state sensor unit 820, an environmental sensor unit 830, an equipment state sensor unit 840, and a user profile sensor unit 850. In the present embodiment, the sensor unit 109 is used to acquire various types of information regarding the viewing status of the user.

The camera unit 810 includes a camera 811 that images the user who is viewing the video content displayed on the image display unit 107, a camera 812 that images the video content displayed on the image display unit 107, and a camera 813 that images the room (alternatively, the installation environment) in which the content reproduction apparatus 100 is installed. The camera 811 that images the user and the camera 812 that images the content may each include a plurality of cameras.

The camera 811 is installed near the center of the upper end edge of the screen of the image display unit 107, for example, and suitably images the user who is viewing the video content. The camera 812 is installed opposing the screen of the image display unit 107, for example, and images the video content that the user is viewing. Alternatively, the user may wear goggles equipped with the camera 812. Furthermore, it is assumed that the camera 812 includes a function of recording also voice of video content. Furthermore, the camera 813 includes, for example, a full-dome camera or a wide-angle camera, and images the room (alternatively, the installation environment) in which the content reproduction apparatus 100 is installed. Alternatively, the camera 813 may be a camera put onto a camera table (camera platform) rotatable about each axis of roll, pitch, and yaw, for example. However, in a case where the environment sensor 830 can acquire sufficient environment data or in a case where environment data itself is unnecessary, the camera 810 is unnecessary.

The user state sensor unit 820 includes one or more sensors that acquire state information regarding the state of the user. The user state sensor unit 820 is intended to acquire state information such as, for example, a work state (presence or absence of viewing of video content) of the user, an action state (movement state such as remaining still, walking, and traveling, eyelid opening/closing state, line-of-sight direction, and pupil size) of the user, a mental state (degree of impression, a degree of excitement, a degree of wakefulness, a feeling, an emotion, or the like such as whether the user is immersed or concentrated in the video content), and a physiological state. The user state sensor unit 820 may include various sensors such as a sweat sensor, a myoelectric potential sensor, an ocular potential sensor, a brain wave sensor, an exhalation sensor, a gas sensor, an ion concentration sensor, and an inertial measurement unit (IMU) that measures the behavior of the user, and an audio sensor (microphone or the like) that collects the utterance of the user. The user state sensor 820 may be attached to the user's body in the form of a wearable device. Note that the microphone is not necessarily integrated with content reproduction apparatus 100, and may be a microphone equipped on a product set down in front of the television such as a sound bar. Furthermore, external microphone-mounted equipment connected in a wired or wireless manner may be used. The external microphone-mounted equipment may be a smart speaker, a wireless headphone/headset, a tablet, a smartphone, a PC, a so-called smart home appliance such as a refrigerator, a washing machine, an air conditioner, a vacuum cleaner, or a lighting fixture, or an IoT home appliance that are equipped with a microphone and capable of audio input.

The environmental sensor unit 830 includes various sensors that measure information regarding the environment such as the room where the content reproduction apparatus 100 is installed. For example, the environmental sensor unit 830 includes a temperature sensor, a humidity sensor, an optical sensor, an illuminance sensor, an airflow sensor, an odor sensor, an electromagnetic wave sensor, a geomagnetic sensor, a global positioning system (GPS) sensor, and an audio sensor (microphone or the like) that collects ambient sound. Furthermore, the environmental sensor unit 830 may acquire information such as the size of the room where the content reproduction apparatus 100 is placed, the number of users in the room, the position of the user (in a case where there is a plurality of users, the position of each user or the center position of the users), the brightness of the room, and the like. The environmental sensor unit 830 may acquire information regarding regional characteristics.

The equipment state sensor unit 840 includes one or more sensors that acquire the internal state of the content reproduction apparatus 100. Alternatively, circuit components such as the video decoding unit 102 and the audio decoding unit 103 may have a function of externally outputting the state of the input signal, the processing status of the input signal, and the like, and may play a role as a sensor that detects the state inside the equipment. Furthermore, the equipment state sensor unit 840 may detect an operation performed by the user on the content reproduction apparatus 100 or another device, or may save a past operation history of the user. The user's operation may include a remote control operation for the content reproduction apparatus 100 and other equipment. The other equipment mentioned here may be a tablet, a smartphone, a PC, a so-called smart home appliance such as a refrigerator, a washing machine, an air conditioner, a vacuum cleaner, or a lighting fixture, or an IoT home appliance. Furthermore, the equipment state sensor unit 840 may acquire information regarding the performance and specifications of the equipment. The equipment state sensor unit 840 may be a memory such as a built-in read only memory (ROM) in which information regarding performance and specifications of the equipment is recorded, or a reader that reads information from such a memory.

The user profile sensor unit 850 detects profile information regarding the user who views video content with the content reproduction apparatus 100. The user profile sensor unit 850 needs not necessarily include a sensor element. For example, user profiles such as the age and gender of the user may be estimated on the basis of a face image of the user imaged by the camera 811, an utterance of the user collected by an audio sensor, or the like. Furthermore, a user profile acquired on a multifunctional information terminal carried by a user such as a smartphone may be acquired by cooperation between the content reproduction apparatus 100 and the smartphone. However, the user profile sensor unit does not need to detect even sensitive information related to privacy and confidentiality of the user. Furthermore, it is not necessary to detect the profile of the same user every time video content is viewed, and the user profile sensor unit may be a memory such as an electrically erasable and programmable ROM (EEPROM) that stores user profile information acquired once.

Furthermore, a multifunctional information terminal carried by the user such as a smartphone may be utilized as the user state sensor unit 820, the environmental sensor unit 830, or the user profile sensor unit 850 by cooperation between the content reproduction apparatus 100 and the smartphone. For example, sensor information acquired by a sensor built in a smartphone, and data managed by applications such as a health care function (pedometer or the like), a calendar, a schedule book, a memorandum, an e-mail, a browser history, and a posting and browsing history of a social network service (SNS) may be added to the state data and the environment data of the user. Furthermore, a sensor built in other CE equipment or an IoT device existing in the space where the content reproduction apparatus 100 is present may be utilized as the user state sensor unit 820 or the environmental sensor unit 830. Furthermore, a visitor may be detected by sound of an intercom, or communication with an intercom system. Furthermore, a luminance meter or a spectrum analysis unit that acquires and analyzes video or audio output from the content reproduction apparatus 100 may be provided as a sensor.

E. Optimization of Content Viewing

It is often the case that the user is bored with content distributed from a television program or a video distribution service, reproduction content of a recording medium, or the like while view them, and does not find content that the user wants to watch next. In such a case, the user needs to switch channels and search for a program that the user wants to watch. The number of channels of the television program is finite, but the number of channels of the video distribution service (alternatively, the number of pieces of content that can be viewed) is enormous, and it is difficult for the user to search for content suitable for the user that may stimulate the user's curiosity from among them.

Therefore, in the present disclosure, by collecting a large amount of reactions of persons who have shown interest in content, information on content of high interest is automatically provided to a user who has become bored with the content being viewed. Furthermore, in the present disclosure, when presenting information on recommended content to the user, a UI that does not hinder content viewing is used, and the user can switch to the recommended content through a UI operation. Note that, in the following, when UI is simply mentioned, it should be understood that a user experience (UX) is included in addition to the UI.

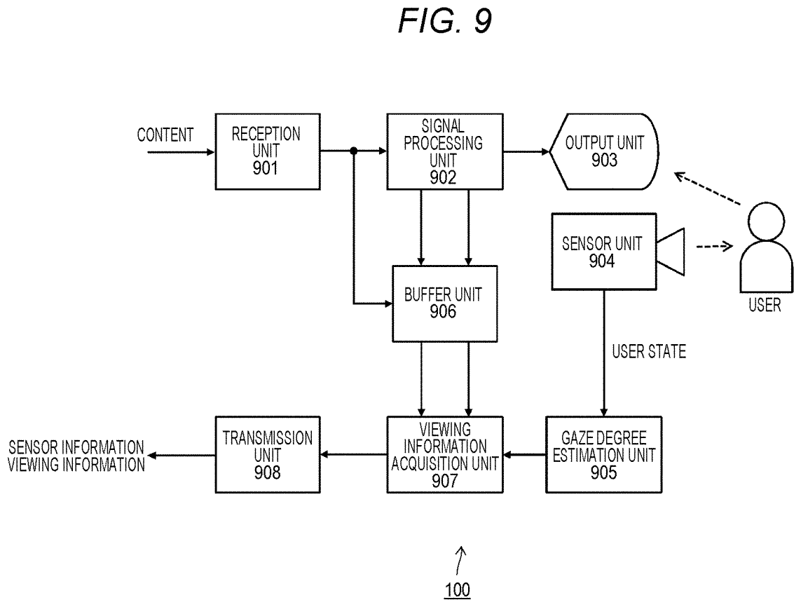

FIG. 9 shows a functional configuration example for collecting reactions of users who have shown interest in content in the content reproduction apparatus 100. The functional configuration shown in FIG. 9 is configured using components in the content reproduction apparatus 100 basically.

A reception unit 901 receives content including video streaming and audio streaming. The received content may include metadata. The content includes broadcast content sent from a broadcasting station (a broadcasting tower, a broadcasting satellite, or the like), streaming content delivered from IPTV, OTT, or a video sharing service, and reproduction content reproduced from a recording medium. Then, the reception unit 901 demultiplexes the received content into video stream, voice stream, and metadata, and outputs them to a signal processing unit 902 and a buffer unit 906 in a subsequent stage. The reception unit 901 corresponds to the external interface unit 110 and the demultiplexer 101 in FIG. 2, for example.

The signal processing unit 902 corresponds to the video decoding unit 102, the audio decoding unit 103, and the signal processing unit 150 in FIG. 2, for example, decodes each of the video stream and the voice stream input from the reception unit 901, and outputs a video signal and an audio signal subjected to the video signal processing and the audio signal processing to the output unit 903. The output unit 903 corresponds to the image display unit 107 and the audio output unit 108 in FIG. 2. Furthermore, the signal processing unit 902 may output a video signal and a voice signal after the signal processing to the buffer unit 906.

The buffer unit 906 includes a video buffer and an audio buffer, and temporarily holds each of the video information and the voice information decoded by the signal processing unit 902 for a certain period. The certain period mentioned here corresponds to processing time required for acquiring a scene gazed by the user from video content, for example.

A sensor unit 904 corresponds to the sensor unit 109 in FIG. 2, and basically includes a sensor group 800 shown in FIG. 8. The sensor unit 904 outputs a face image of the user imaged by the camera 811, biological information sensed by the user state sensor unit 820, and the like to a gaze degree estimation unit 905 while the user is viewing content output from the output unit 903. Furthermore, the sensor unit 904 may also output, to the gaze degree estimation unit 905, an image imaged by the camera 813, indoor environment information sensed by the environmental sensor unit 830, and the like.

The gaze degree estimation unit 905 estimates the gaze degree of the video content being viewed by the user on the basis of the sensor information output from the sensor unit 904. In the present embodiment, it is assumed that, by an artificial intelligence model, the gaze degree estimation unit 905 performs processing of estimating the gaze degree of the user on the basis of sensor information. For example, the gaze degree estimation unit 905 estimates the gaze degree of the user on the basis of the image recognition result of the facial expression such as dilating of the pupil of the user or opening of the mouth largely. Of course, the gaze degree estimation unit 905 may also input sensor information other than an image imaged by the camera 811 and estimate the gaze degree of the user by an artificial intelligence model.

The viewing information acquisition unit 907 acquires, from the buffer unit 906, a video and audio stream when the gaze degree estimation unit 905 estimates a high gaze degree of the user, that is, at the same time or several seconds back from the time as the reaction by the user showing interest in the content that the user is viewing. Then, the transmission unit 908 transmits viewing information including the video and voice stream in which the user has shown interest to an artificial intelligence server on the cloud together with the sensor information at that time. The viewing information acquisition unit 907 is arranged in the signal processing unit 150 in FIG. 2, for example. Furthermore, the transmission unit 908 corresponds to the external interface unit 110 in FIG. 2, for example.

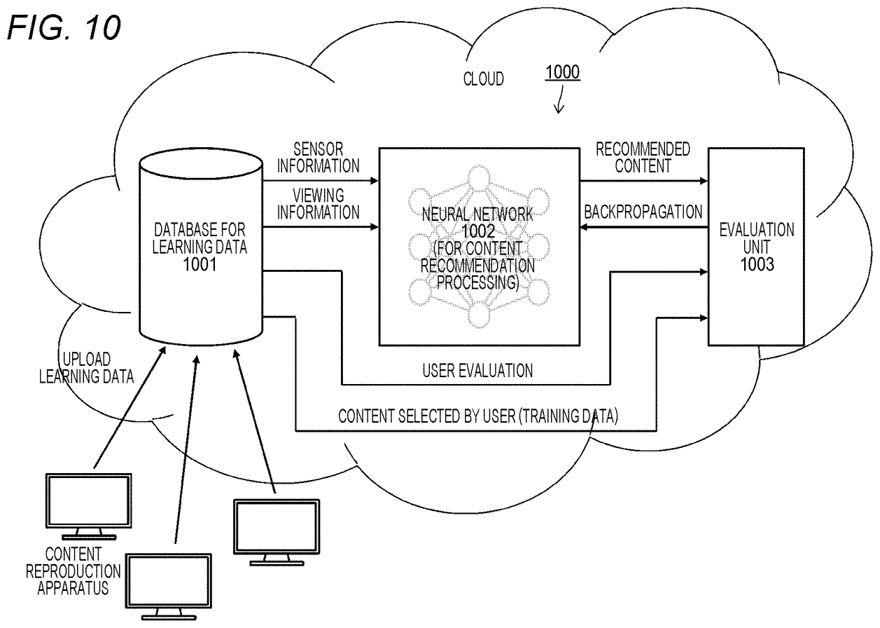

The artificial intelligence server can collect, from a large number of content reproduction apparatuses, a large amount of reactions of persons who have shown interest in content, that is, viewing information in which the user has shown interest and sensor information. Then, using, as learning data, information collected from a large number of content reproduction apparatuses, the artificial intelligence server performs deep learning of the artificial intelligence model for estimating content in which the user who has become bored with the content being viewed shows high interest. The artificial intelligence model is represented by a neural network. FIG. 10 schematically shows a functional configuration example of the artificial intelligence server 1000 that performs deep learning on the neural network used for the processing of estimating the content in which the user who has been bored with the content being viewed shows high interest. The artificial intelligence server 1000 is assumed to be constructed on the cloud.

A database 1001 for learning data accumulates enormous learning data uploaded from a large number of content reproduction apparatuses 100 (for example, television receiver of each household). It is assumed that the learning data includes viewing information and sensor information in which the user shows interest acquired by each content reproduction apparatus, and an evaluation value for the viewed content. The evaluation value may be, for example, a simple evaluation (Good or Bad) by the user for the viewed content.

A neural network 1002 for content recommendation processing estimates optimal content matching the user from the causal relationship between viewing information read from the database 1001 for learning data and sensor information.

An evaluation unit 1003 evaluates a learning result of the neural network 1002. Specifically, the evaluation unit 1003 defines a loss function based on a difference between the recommended content output from the neural network 1002 and the video stream output from the neural network 1002 when the training data read from the database 1001 for learning data is input. The training data is viewing information of the content selected next by the user who has been bored with the content being viewed, for example, and an evaluation result by the user for the selected content. Note that the loss function may be defined by performing weighting such as increasing a weight of a difference from training data having a high evaluation result from the user and increasing a difference from training data having a low evaluation result from the user. Then, the evaluation unit 1003 performs deep learning of the neural network 1002 by backpropagation so as to minimize the loss function.

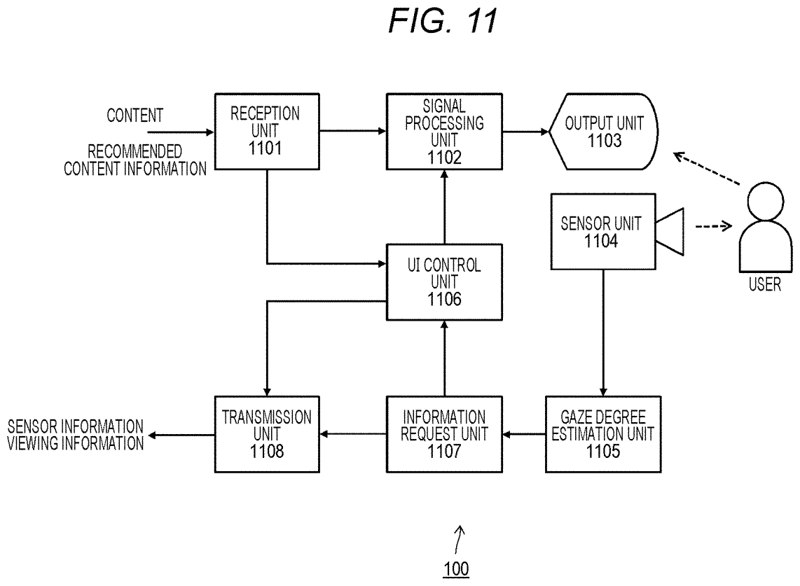

FIG. 11 shows a functional configuration for presenting information on recommended content to the user when the user is bored with the content being viewed in the content reproduction apparatus 100. The functional configuration shown in FIG. 11 is configured using components in the content reproduction apparatus 100 basically.

A reception unit 1101 receives content including video streaming and audio streaming. The received content may include metadata. The content includes broadcast content, streaming content delivered from IPTV, OTT, or a video sharing service, and reproduction content reproduced from a recording medium. Then, the reception unit 1101 demultiplexes the received content into video stream, voice stream, and metadata, and outputs them to a signal processing unit 1102 in a subsequent stage. The reception unit 1101 corresponds to the external interface unit 110 and the demultiplexer 101 in FIG. 2, for example.

The signal processing unit 1102 corresponds to the video decoding unit 102, the audio decoding unit 103, and the signal processing unit 150 in FIG. 2, for example, decodes each of the video stream and the voice stream input from the reception unit 1101, and outputs a video signal and an audio signal subjected to the video signal processing and the audio signal processing to the output unit 1103. The output unit 1103 corresponds to the image display unit 107 and the audio output unit 108 in FIG. 2.

A sensor unit 1104 corresponds to the sensor unit 109 in FIG. 2, and basically includes a sensor group 800 shown in FIG. 8. The sensor unit 1104 outputs a face image of the user imaged by the camera 811, biological information sensed by the user state sensor unit 820, and the like to a gaze degree estimation unit 1105 while the user is viewing content output from the output unit 1103. Furthermore, the sensor unit 1104 may also output, to the gaze degree estimation unit 1105, an image imaged by the camera 813, indoor environment information sensed by the environmental sensor unit 830, and the like.

The gaze degree estimation unit 1105 estimates the gaze degree of the video content being viewed by the user on the basis of the sensor information output from the sensor unit 1104. Since the gaze degree of the user is estimated by processing similar to that of the gaze degree estimation unit 905 (see FIG. 9) when collecting reactions of the user who has shown interest in content, a detailed description will be omitted here.

In a case where an estimation result of the gaze degree estimation unit 1105 indicates that the user has been bored with the content being viewed, an information request unit 1107 requests information on the content that should be recommended to the user. Specifically, the information request unit 1107 performs an operation of transmitting the viewing information of the content viewed by the user and the sensor information at that time from the transmission unit 1108 to a content recommendation system on the cloud. Furthermore, the information request unit 1107 instructs an UI control unit 1106 for display operation of a UI screen when the user gets bored with the content being viewed, and UI display of information on the content provided from the content recommendation system. The information request unit 1107 is arranged in the signal processing unit 150 in FIG. 2, for example. Furthermore, the transmission unit 1108 corresponds to the external interface unit 110 in FIG. 2, for example.

Details of the content recommendation system will be described later. The reception unit 1101 receives information on the content that should be recommended to the user from the content recommendation system.

The UI control unit 1106 performs display operation of a UI screen when the user gets bored with the content being viewed, and UI display of information on the content provided from the content recommendation system.

Here, in the content reproduction apparatus 100, a screen transition example according to a change in the gaze degree of the content being viewed by the user will be described with reference to FIGS. 12 to 16.

FIG. 12 shows a display screen immediately after the start of content reproduction. The content includes broadcast content, streaming content delivered from IPTV, OTT, or a video sharing service, and reproduction content reproduced from a recording medium. Immediately after reproduction of content is started (immediately after channel switching, immediately after start of streaming reception, immediately after start of reproduction from recording medium, and the like), video of the reproduction content is displayed on a full screen. Thereafter, while the user's gaze degree or interest in this reproduction content is kept high, the full screen display of the reproduction content is maintained.

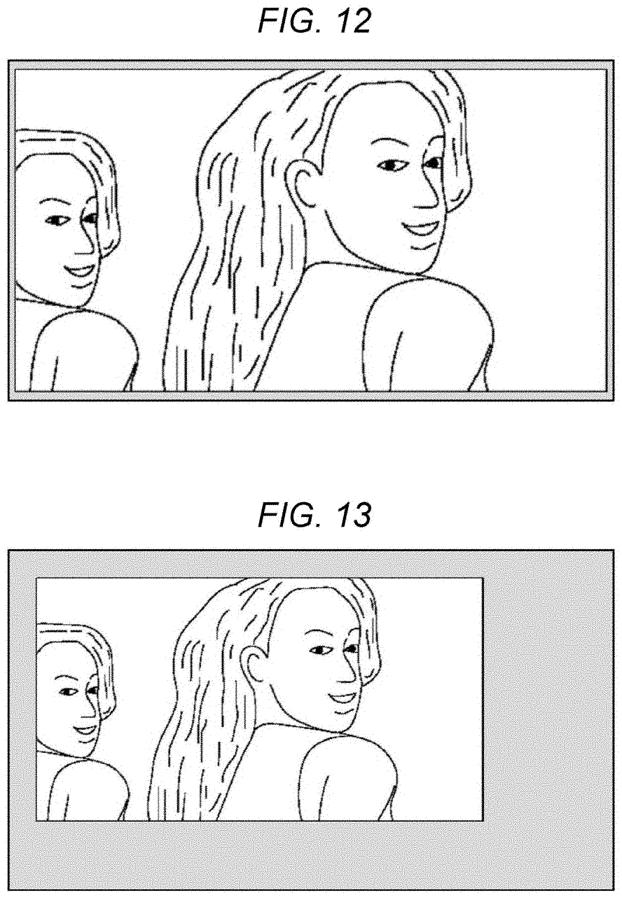

Thereafter, when the user's gaze degree or interest in the reproduction content decreases, the display region of reproduction content is shrunk as shown in FIG. 13, and a free space occurs in the peripheral part of the screen. Furthermore, when the user's gaze degree or interest in the reproduction content further decreases, as shown in FIG. 14, the display region of reproduction content may be further shrunk according to the degree of decrease.

Note that, in a case where the content reproduction apparatus 100 is configured to be equipped with the direction equipment 110 as shown in FIG. 6, the direction control unit 111 may control the direction equipment 110 on the basis of the gaze degree of the user to the reproduction content. In a case where the user is gazing at or immersing in the content being reproduced, it is possible to enhance the realistic feeling of the user and realize the bodily sensation type direction by operating the direction equipment 110 to produce a direction effect. On the other hand, if a direction effect is given when the gaze degree or interest of the user with respect to the reproduction content is reduced, it becomes annoying to the user. Therefore, the direction control unit 111 may suppress output of the direction equipment 110 or stop the operation of the direction equipment 110 when the gaze degree of the user with respect to the reproduction content decreases.

In any case, a space for displaying information on recommended content provided from the content recommendation system is secured around the display region of the reproduction content in which the interest of the user has decreased. Furthermore, in the background where the screen is transitioned, the content reproduction apparatus 100 performs processing of transmitting the viewing information of the content viewed by the user and the sensor information at that time to the content recommendation system on the cloud, acquiring information on the content to be recommended from the content recommendation system, and performing UI display.

Note that, in a case where a delay time occurs until information on recommended content is delivered from the content recommendation system after the display region of the reproduction content is shrunk, the free space may be left as it is, or the free space may be filled with other content such as advertisement information.

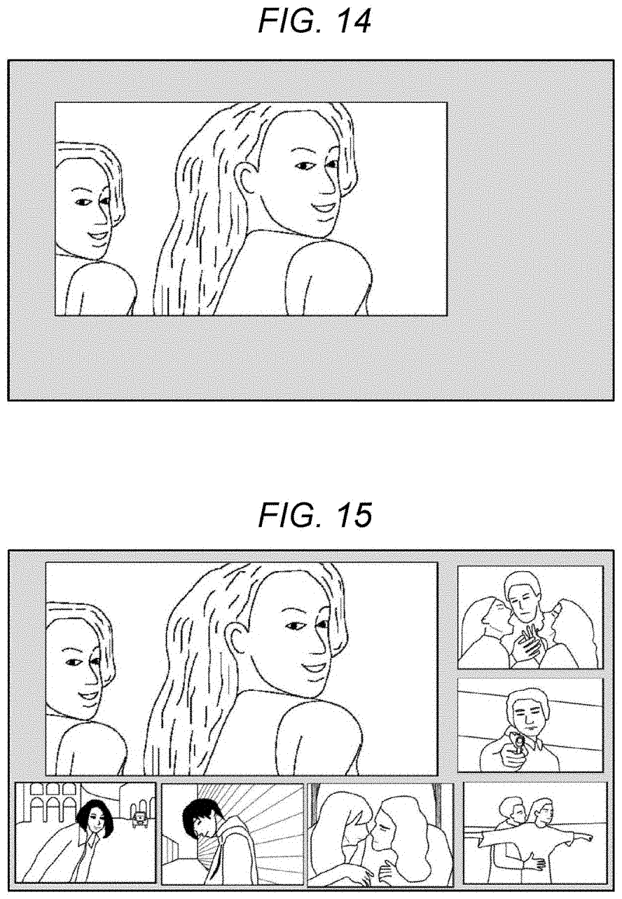

Then, when information on the recommended content arrives from the content recommendation system, the content reproduction apparatus 100 performs a UI display operation of the recommended content. FIG. 15 shows a screen configuration example in which information on recommended content is displayed in a free space. In the example shown in FIG. 15, a thumbnail image of the content is displayed as the information on the recommended content, but related information to the content (for example, content of a broadcast program) may be displayed. Note that, in a case where the free space is not filled even when all pieces of information on the recommended content sent from the content recommendation system is displayed, other content such as advertisement information may be displayed in a space that is not filled. Furthermore, as shown in FIG. 16, related information to the content may be guided by the voice of an avatar.

As shown in FIGS. 12 to 16, according to the method of shrinking the display region of the reproduction content to shrink the display region of the recommended content and secure the display region of the recommended content, the user can confirm the related information on the recommended content without interrupting viewing of the original reproduction content. Furthermore, the user can select content desired to be viewed next through a UI operation (for example, clicking with a mouse, touching with a touchscreen, or the like) in the display region of the recommended content.

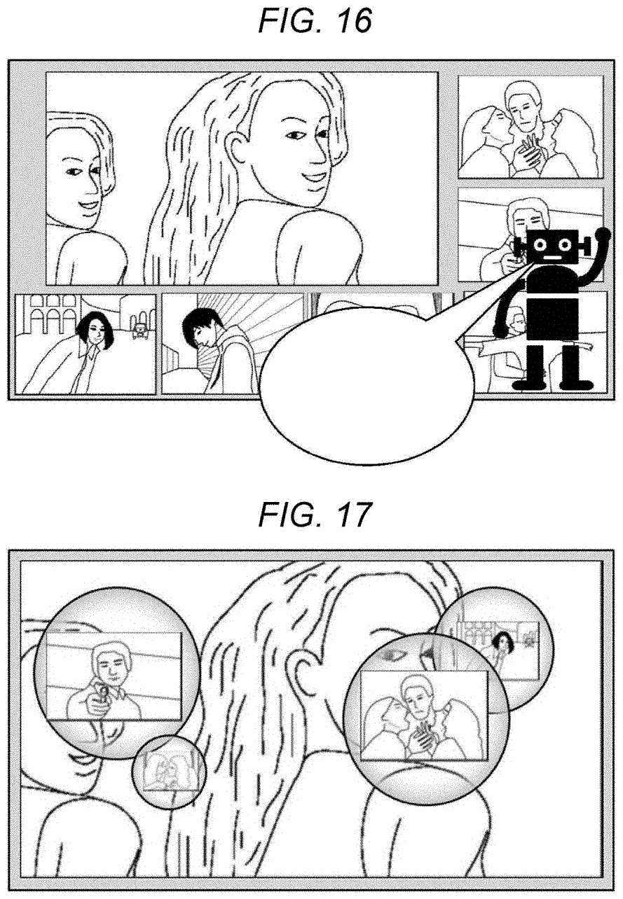

FIG. 17 shows another configuration example of a screen displaying related information on recommended content on a content reproduction screen. In the example shown in FIG. 17, the display region of reproduction content is not shrunk. Alternatively, the display region of reproduction content may be shrunk. Then, bubbles that come up and disappear are superimposed and displayed in the display region of reproduction content, and related information on the recommended content is displayed using the bubbles. When the bubbles come up, it is temporarily difficult to see the reproduction content, but the bubbles disappear quickly. Therefore, the user can confirm the related information on the recommended content without interrupting viewing the original reproduction content. Furthermore, the user can select content desired to be viewed next through a UI operation (for example, clicking with a mouse, touching with a touchscreen, or the like) for the bubble of the content desired to be viewed next. Of course, similarly to FIG. 16, the related information on the content may be guided by the voice of an avatar.

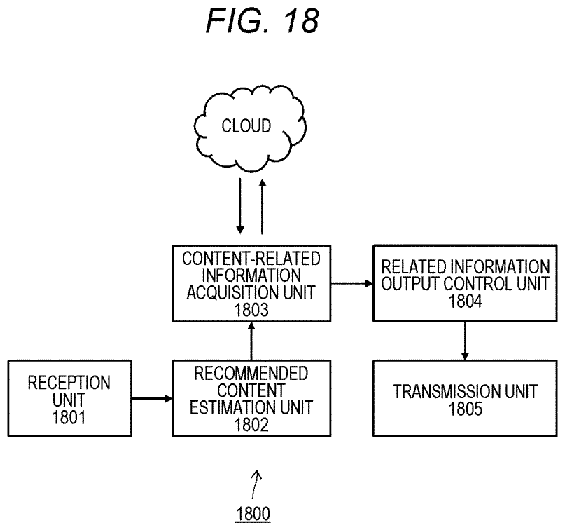

FIG. 18 shows a functional configuration example of the content recommendation system 1800 that provides the content reproduction apparatus 100 with information on content recommended to the user. The content recommendation system 1800 is assumed to be constructed on the cloud. However, a part of or entire processing of the content recommendation system 1800 can be incorporated into the content reproduction apparatus 100.

A reception unit 1801 receives viewing information of the content viewed by the user and sensor information at that time from the content reproduction apparatus 100 of a request source.

A recommended content estimation unit 1802 estimates content to be recommended to the user from the causal relationship between the viewing information received from the content reproduction apparatus 100 of the request source and the sensor information. It is assumed that the recommended content estimation unit 1802 estimates content recommended to the user using the neural network 1002 on which deep learning has been performed by the artificial intelligence server 1000 shown in FIG. 10. The recommended content estimation unit 1802 preferably estimates a plurality of pieces of content in order to give the user a selection range.

A content-related information acquisition unit 1803 retrieves and acquires, on the cloud, related information on each content estimated by the recommended content estimation unit 1802. In a case where the content is content of a broadcast program, the related information on the content includes text data such as a program name, a performer name, a summary of the program content, and a keyword, for example.

A related information output control unit 1804 performs output control for presenting the user the related information on the content that the content-related information acquisition unit 1803 has acquired by retrieving the cloud. There are various methods to present related information to the user. For example, there are a method of displaying a list of related information on content in a free space secured by shrinking a display region of reproduction content (see, for example, FIGS. 13 to 15), a method of displaying related information on content by using bubbles that come up and disappear (see, for example, FIG. 17), and a method of guiding related information on content by using an avatar (see, for example, FIG. 16). The related information output control unit 1804 generates control information of a UI for presenting related information using these methods.

A transmission unit 1805 replies the related information on content and its output control information to the content reproduction apparatus 100 of a request source. The content reproduction apparatus 100 side of the request source performs UI display of information on content provided by the content recommendation system on the basis of the related information on content received from the content recommendation system 1800 and the output control information.

When the user gets bored with the content being reproduced by the content reproduction apparatus 100, information on recommended content provided from the content recommendation system is presented on a UI that does not hinder viewing of content. Then, the user can switch to recommended content through the UI operation.

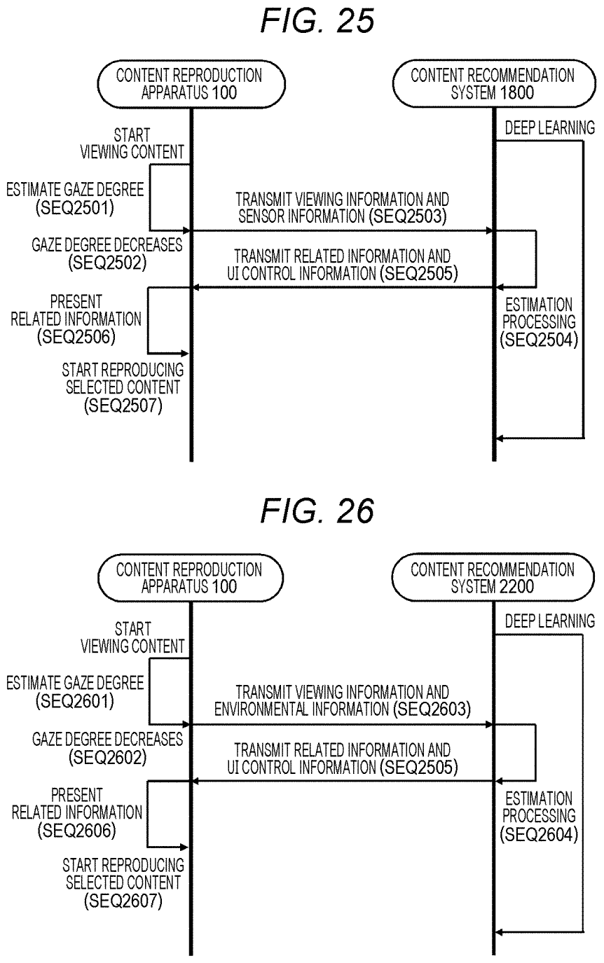

FIG. 25 shows a sequence example executed between the content reproduction apparatus 100 and the content recommendation system 1800.

The content recommendation system 1800 continuously execute deep learning of an artificial intelligence model for content recommendation processing.

On the other hand, when reproduction of content is started, that is, viewing of the content by the user is started, the content reproduction apparatus 100 executes gaze degree estimation processing of the user (SEQ 2501).

Thereafter, when estimating that the gaze degree of the user has decreased, that is, the user has been bored with the content being reproduced (SEQ 2502), the content reproduction apparatus 100 transmits viewing information and sensor information to the content recommendation system 1800, and requests the user to provide information on recommended content (SEQ 2503).

Using a deep-learned artificial intelligence model, the content recommendation system 1800 estimates the optimal content matching the user from the causal relationship between the viewing information sent from the content reproduction apparatus 100 and the sensor information, further retrieves for and acquires related information on each content on the cloud, generates control information on the UI that presents the related information on the content (SEQ 2504), and transmits the related information on the recommended content and the control information of the UI to the content reproduction apparatus 100 (SEQ 2505).

When estimating that the user has been bored with the content being viewed, the content reproduction apparatus 100 shrinks the display region of reproduction content on the screen of the image display unit 107. Then, upon receiving related information on recommended content and control information of the UI from the content recommendation system 1800, the content reproduction apparatus 100 displays the related information on the recommended content in the free space obtained by shrinking the display region of the reproduction content (SEQ 2506). Furthermore, when the user selects content desired to view next through an UI operation, reproduction of the content being reproduced is stopped, and reproduction of the content selected by the user is started (SEQ 2507).

F. Optimization of Content Viewing for Regions

In the present disclosure, by collecting a large amount of reactions of persons who have shown interest in content, information on content of high interest is automatically provided to a user who has become bored with the content being viewed. Furthermore, in the present disclosure, by also collecting environment information where the user is viewing content, it is possible to provide the user with information on content in accordance with regional characteristics, leading to activation of regional events and improvement in consumption for the region. Furthermore, in the present disclosure, when presenting information on recommended content to the user, a UI that does not hinder content viewing is used, and the user can switch to the recommended content through a UI operation.

Note that the regional characteristics mentioned here mean characteristics according to administrative divisions such as country, prefecture, and municipality, or differences in geography or topography. As extended interpretation, regional characteristics may include characteristics according to differences in space, the number of persons under viewing environment (for example, in a room), the content of conversation, brightness, temperature, humidity, and smell.

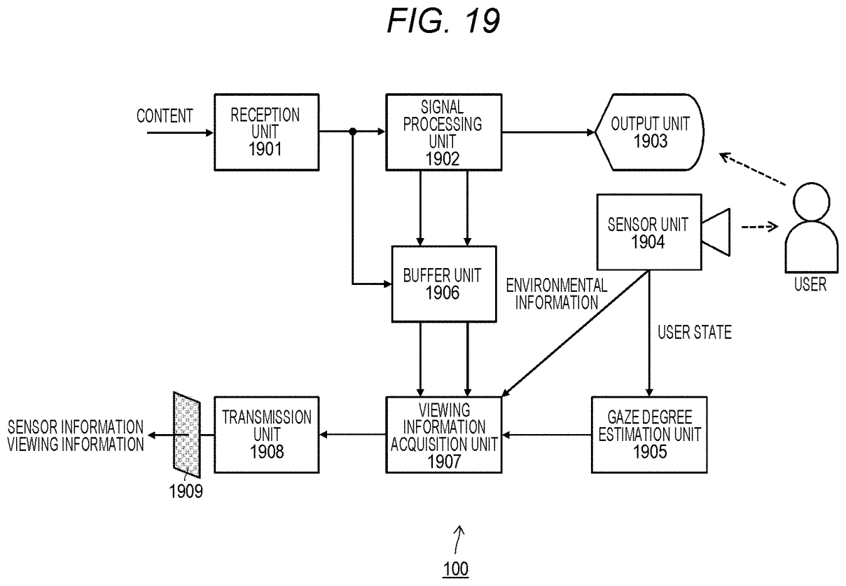

FIG. 19 shows a functional configuration example for collecting reactions of users who have shown interest in content in the content reproduction apparatus 100. The functional configuration shown in FIG. 19 is configured using components in the content reproduction apparatus 100 basically.

The reception unit 1901 receives content including video streaming and audio streaming. The received content may include metadata. The content includes broadcast content sent from a broadcasting station (a broadcasting tower, a broadcasting satellite, or the like), streaming content delivered from IPTV, OTT, or a video sharing service, and reproduction content reproduced from a recording medium. Then, the reception unit 901 demultiplexes the received content into video stream, voice stream, and metadata, and outputs them to a signal processing unit 1902 and a buffer unit 1906 in a subsequent stage. The reception unit 1901 corresponds to the external interface unit 110 and the demultiplexer 101 in FIG. 2, for example.

The signal processing unit 1902 corresponds to the video decoding unit 102, the audio decoding unit 103, and the signal processing unit 150 in FIG. 2, for example, decodes each of the video stream and the voice stream input from the reception unit 1901, and outputs a video signal and an audio signal subjected to the video signal processing and the audio signal processing to the output unit 1903. The output unit 1903 corresponds to the image display unit 107 and the audio output unit 108 in FIG. 2. Furthermore, the signal processing unit 1902 may output a video signal and a voice signal after the signal processing to the buffer unit 1906.

The buffer unit 1906 includes a video buffer and an audio buffer, and temporarily holds each of the video information and the voice information decoded by the signal processing unit 1902 for a certain period. The certain period mentioned here corresponds to processing time required for acquiring a scene gazed by the user from video content, for example.

A sensor unit 1904 corresponds to the sensor unit 109 in FIG. 2, and basically includes a sensor group 800 shown in FIG. 8. The sensor unit 1904 outputs a face image of the user imaged by the camera 811, biological information sensed by the user state sensor unit 820, and the like to a gaze degree estimation unit 1905 while the user is viewing content output from the output unit 903. Furthermore, the sensor unit 904 may also output, to the viewing information acquisition unit 1905, an image imaged by the camera 813, indoor environment information sensed by the environmental sensor unit 830, and the like.

The gaze degree estimation unit 1905 estimates the gaze degree of the video content being viewed by the user on the basis of the sensor information output from the sensor unit 1904. In the present embodiment, it is assumed that, by an artificial intelligence model, the gaze degree estimation unit 1905 performs processing of estimating the gaze degree of the user on the basis of sensor information. For example, the gaze degree estimation unit 1905 estimates the gaze degree of the user on the basis of the image recognition result of the facial expression such as dilating of the pupil of the user or opening of the mouth largely. Of course, the gaze degree estimation unit 1905 may also input sensor information other than an image imaged by the camera 811 and estimate the gaze degree of the user by an artificial intelligence model.

A viewing information acquisition unit 1907 acquires, from the buffer unit 1906, a video and audio stream when the gaze degree estimation unit 1905 estimates a high gaze degree of the user, that is, at the same time or several seconds back from the time as the reaction by the user showing interest in the content that the user is viewing. Furthermore, the viewing information acquisition unit 1907 acquires the environment information in which the user is viewing the content from the sensor unit 1904. Then, a transmission unit 1908 transmits viewing information including the video and voice stream in which the user has shown interest to an artificial intelligence server on the cloud together with the sensor information at that time including user state and environment information.

However, sensor information such as environment information may include sensitive information. Therefore, sensor information such as environment information is applied to a filter 1909 so that problems such as invasion of privacy do not occur. The viewing information acquisition unit 1907 is arranged in the signal processing unit 150 in FIG. 2, for example. Furthermore, the transmission unit 1908 corresponds to the external interface unit 110 in FIG. 2, for example. Furthermore, although the filter 1909 is arranged on the output side of the transmission unit 1908, it may be arranged on the output side of the sensor unit 1904 or the cloud side.

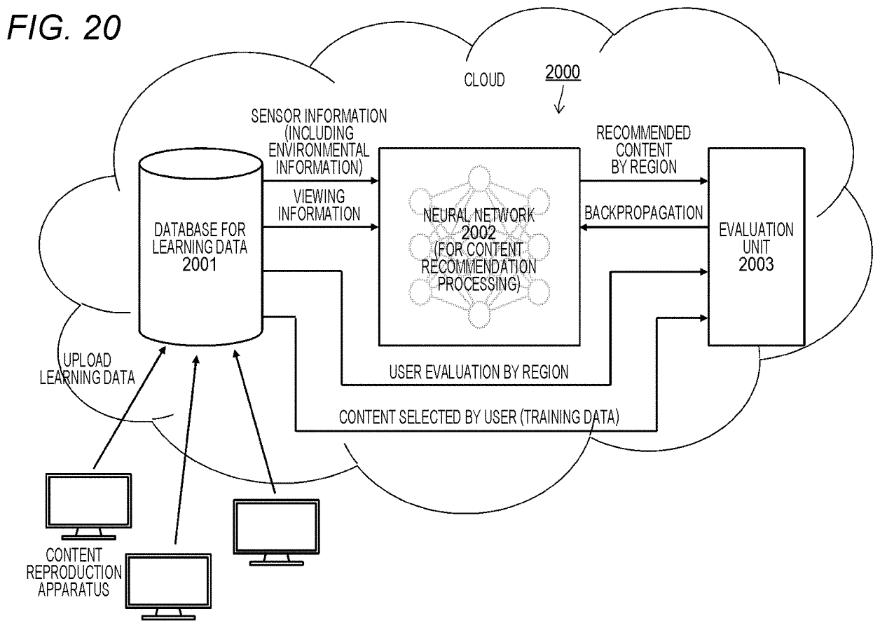

The artificial intelligence server can collect, from a large number of content reproduction apparatuses, a large amount of reactions of persons who have shown interest in content, that is, viewing information in which the user has shown interest and sensor information including the state of the user viewing content and environment information. Then, using, as learning data, information collected from a large number of content reproduction apparatuses, the artificial intelligence server performs deep learning of the artificial intelligence model for estimating content matching the user in accordance with the regional characteristics. The artificial intelligence model is represented by a neural network. FIG. 20 schematically shows a functional configuration example of the artificial intelligence server 2000 that performs deep learning on the neural network used for the processing of estimating the content in which the user who has been bored with the content being viewed shows high interest. The artificial intelligence server 2000 is assumed to be constructed on the cloud.

A database 2001 for learning data accumulates enormous learning data uploaded from a large number of content reproduction apparatuses 100 (for example, television receiver of each household). It is assumed that the learning data includes viewing information and sensor information in which the user shows interest acquired by each content reproduction apparatus, and an evaluation value for the viewed content. The sensor information includes a user state and environment information. Furthermore, the evaluation value may be, for example, a simple evaluation (Good or Bad) by the user for the viewed content.

A neural network 2002 for content recommendation processing estimates content matching the user in accordance with regional characteristics from a causal relationship between viewing information read from the database 2001 for learning data and sensor information such as environment information. Note that the content recommended here may include an event held in a region, a concert, a promotion activity of an artist, and a movie.

An evaluation unit 2003 evaluates a learning result of the neural network 2002. Specifically, the evaluation unit 2003 defines a loss function based on a difference between the recommended content for each region output from the neural network 2002 and the video stream output from the neural network 2002 when the training data read from the database 2001 for learning data is input. The training data is viewing information of the content selected next by the user who has been bored with the content being viewed, for example, and an evaluation result by the user for each region for the selected content. Note that the loss function may be defined by performing weighting such as increasing a weight of a difference from training data having a high evaluation result from the user and increasing a difference from training data having a low evaluation result from the user. Then, the evaluation unit 2003 performs deep learning of the neural network 2002 by backpropagation so as to minimize the loss function.

Deep learning of the neural network 2002 is performed “in accordance with regional characteristics”. Therefore, even if users in different regions get bored similarly while viewing the same content, the neural network 2002 may learn to match different content to the users in each region due to the difference in regional characteristics. By performing matching between the user and content in accordance with regional characteristics through the neural network 2002, it is expected to lead to activation of regional events and improvement in consumption for the region.

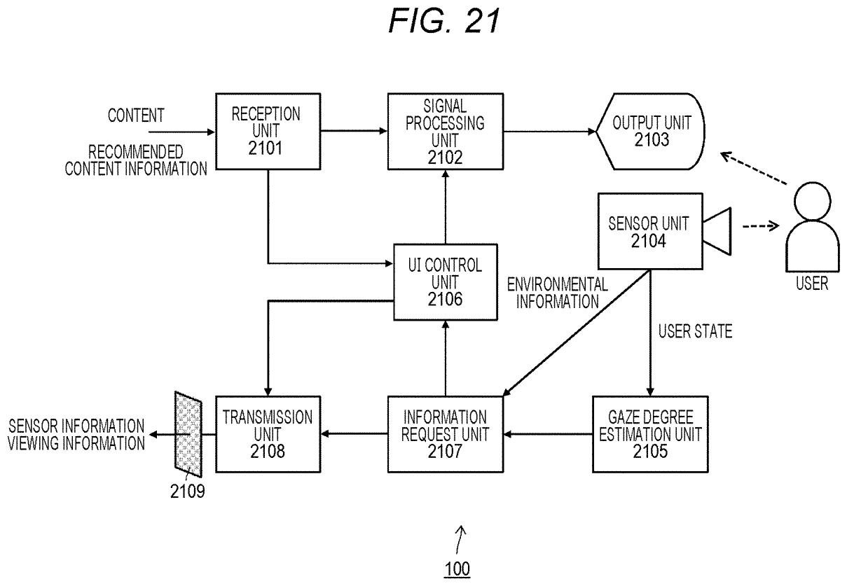

FIG. 21 shows a functional configuration for presenting information on recommended content in accordance with regional characteristics to the user when the user has been bored with the content being viewed in the content reproduction apparatus 100. The functional configuration shown in FIG. 21 is configured using components in the content reproduction apparatus 100 basically.

A reception unit 2101 receives content including video streaming and audio streaming. The received content may include metadata. The content includes broadcast content, streaming content delivered from IPTV, OTT, or a video sharing service, and reproduction content reproduced from a recording medium. Then, the reception unit 2101 demultiplexes the received content into video stream, voice stream, and metadata, and outputs them to a signal processing unit 2102 in a subsequent stage. The reception unit 1101 corresponds to the external interface unit 110 and the demultiplexer 101 in FIG. 2, for example.

The signal processing unit 2102 corresponds to the video decoding unit 102, the audio decoding unit 103, and the signal processing unit 150 in FIG. 2, for example, decodes each of the video stream and the voice stream input from the reception unit 2101, and outputs a video signal and an audio signal subjected to the video signal processing and the audio signal processing to the output unit 2103. The output unit 2103 corresponds to the image display unit 107 and the audio output unit 108 in FIG. 2.

A sensor unit 2104 corresponds to the sensor unit 109 in FIG. 2, and basically includes a sensor group 800 shown in FIG. 8. The sensor unit 2104 outputs a face image of the user imaged by the camera 811, biological information sensed by the user state sensor unit 820, and the like to the gaze degree estimation unit 905 while the user is viewing content output from the output unit 2103. Furthermore, the sensor unit 2104 may also output, to the gaze degree estimation unit 2105, an image imaged by the camera 813, indoor environment information sensed by the environmental sensor unit 830, and the like. Therefore, sensor information such as environment information is applied to a filter 2109 so that problems such as invasion of privacy do not occur.

The gaze degree estimation unit 2105 estimates the gaze degree of the video content being viewed by the user on the basis of the sensor information output from the sensor unit 2104. Since the gaze degree of the user is estimated by processing similar to that of the gaze degree estimation unit 905 (see FIG. 9) when collecting reactions of the user who has shown interest in content, a detailed description will be omitted here.

In a case where an estimation result of the gaze degree estimation unit 2105 indicates that the user has been bored with the content being viewed, an information request unit 2107 requests information on the content that should be recommended to the user. Specifically, the information request unit 2107 performs an operation of transmitting the viewing information of the content viewed by the user and the sensor information including the user state and environment information at that time from the transmission unit 2108 to a content recommendation system on the cloud. Furthermore, the information request unit 2107 instructs an UI control unit 2106 for display operation of a UI screen when the user gets bored with the content being viewed, and UI display of information on the content provided from the content recommendation system. The information request unit 2107 is arranged in the signal processing unit 150 in FIG. 2, for example. Furthermore, the transmission unit 2108 corresponds to the external interface unit 110 in FIG. 2, for example. Furthermore, although the filter 2109 is arranged on the output side of the transmission unit 2108, it may be arranged on the output side of the sensor unit 2104 or the cloud side.

Details of the content recommendation system will be described later. The reception unit 2101 receives, from a content recommendation system, information on content that should be recommended to the user in accordance with regional characteristics.

The UI control unit 2106 performs display operation of a UI screen when the user gets bored with the content being viewed, and UI display of information on the content provided from the content recommendation system.

The screen transition according to a change in the gaze degree of the content being viewed by the user is similar to that in the example shown in FIGS. 12 to 17, for example. However, since the content recommendation system performs matching between the user and the content in accordance with regional characteristics, even if users in different regions get bored similarly while viewing the same content, there is a case where different content is recommended due to the difference in regional characteristics. Therefore, in the content reproduction apparatus 100 for each region, when the user gets bored with the content being viewed, recommended content in accordance with regional characteristics is presented, and thus it is expected to lead to activation of regional events and improvement in consumption for the region.

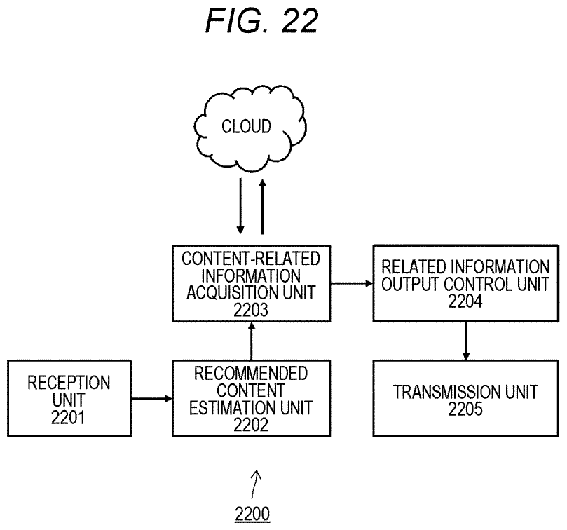

FIG. 22 shows a functional configuration example of the content recommendation system 2200 that provides the content reproduction apparatus 100 with information on content recommended to the user. The content recommendation system 2200 is assumed to be constructed on the cloud. However, a part of or entire processing of the content recommendation system 2200 can be incorporated into the content reproduction apparatus 100.

A reception unit 2201 receives viewing information of the content viewed by the user and sensor information including the user state and the environment information at that time from the content reproduction apparatus 100 of a request source.

A recommended content estimation unit 2202 estimates content matching the user in accordance with the regional characteristics from the causal relationship between the viewing information received from the content reproduction apparatus 100 as the request source and the sensor information including the user state and the environment information. It is assumed that the recommended content estimation unit 2202 estimates content recommended to the user using the neural network 2002 on which deep learning has been performed by the artificial intelligence server 2000 shown in FIG. 20. The recommended content estimation unit 2202 preferably estimates a plurality of pieces of content in order to give the user a selection range.

A content-related information acquisition unit 2203 retrieves and acquires, on the cloud, related information on each content estimated by the recommended content estimation unit 2202. In a case where the content is content of a broadcast program, the related information on the content includes text data such as a program name, a performer name, a summary of the program content, and a keyword, for example. Furthermore, the content recommended here may include an event held in a region, a concert, a promotion activity of an artist, and a movie. The related information on the content in this case includes information such as a venue of the event, a date and time of the event, event participants, and an entrance fee.

A related information output control unit 2204 performs output control for presenting the user the related information on the content that the content-related information acquisition unit 2203 has acquired by retrieving the cloud. There are various methods to present related information to the user. For example, there are a method of displaying a list of related information on content in a free space secured by shrinking a display region of reproduction content (see, for example, FIGS. 13 to 15), a method of displaying related information on content by using bubbles that come up and disappear (see, for example, FIG. 17), and a method of guiding related information on content by using an avatar (see, for example, FIG. 16). The related information output control unit 2204 generates control information of a UI for presenting related information using these methods.

A transmission unit 2205 replies the related information on content and its output control information to the content reproduction apparatus 100 of a request source. The content reproduction apparatus 100 side of the request source performs UI display of information on content provided by the content recommendation system on the basis of the related information on content received from the content recommendation system 2200 and the output control information.

When the user gets bored with the content being reproduced by the content reproduction apparatus 100, information on recommended content provided from the content recommendation system is presented on a UI that does not hinder viewing of content. Then, the user can switch to recommended content through the UI operation. Furthermore, the content recommendation system recommends content in accordance with regional characteristics. Therefore, by performing matching between the user and content in accordance with regional characteristics, it is expected to lead to activation of regional events and improvement in consumption for the region.

Furthermore, as extended interpretation of regional characteristics, regional characteristics include characteristics according to differences in space, the number of persons under viewing environment (for example, in a room), the content of conversation, brightness, temperature, humidity, and smell. Regardless of scale, the region may be a gathering (community) of people who have a common interest and exchange information, and regional characteristics also include characteristics of the community.

For example, in a situation where a plurality of groups of users is gathered in a lump in the large-scale dome screen 500, and content selected for each group of users or a UI for each group of users is projected and displayed, a community is made for each group of gathered users, and each group has individual regional characteristics. Therefore, in the dome screen 500, UI control is performed in which the gaze degree of the user with respect to the reproduction content is estimated for each group of users, and the content recommendation and the recommended content are presented for each group of users (that is, in accordance with the regional characteristics) according to the change in the gaze degree.

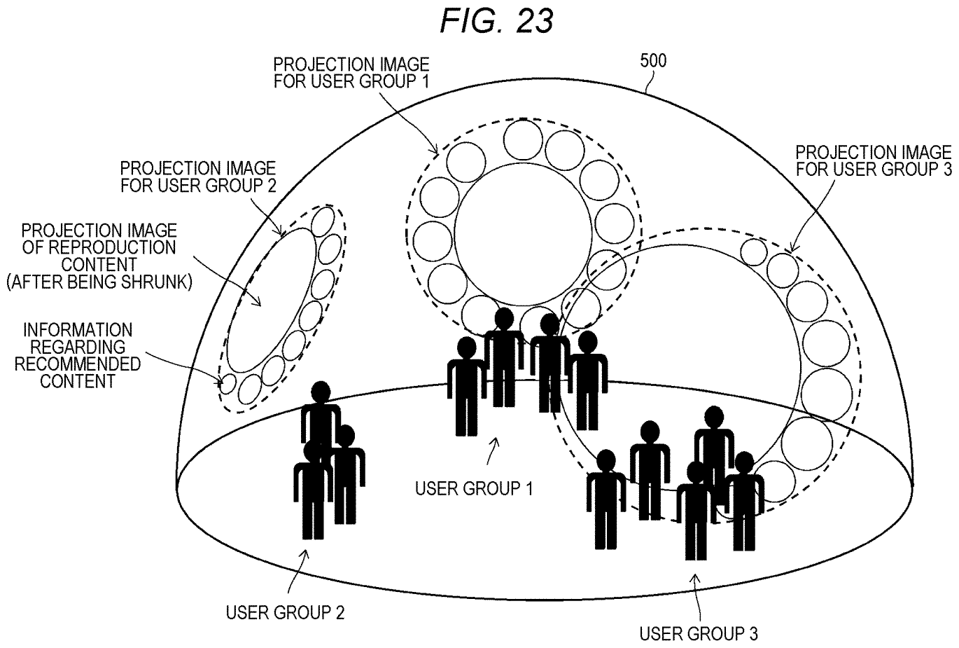

FIG. 23 shows a state of performing UI control in which, when it is estimated that the gaze degree of the user to reproduction content has decreased in each of the user groups 1 to 3, the projection image of the reproduction content is shrunk on the basis of the estimation result, and related information on the recommended content is displayed in a free space.

Even if all the user groups view the same content at first, when it is estimated that each user group gets bored with the content, the content recommendation system matches different content for each user group from a difference in characteristics of each user group, that is, a difference in regional characteristics. Then, a UI for recommending different content for each user group is projected and displayed. Furthermore, the timing at which the user gets bored during viewing is also different for each user group, and the timing of transitioning to the UI for recommending content also varies depending on each user group.

Furthermore, a community is configured for each household sharing one content reproduction apparatus 100 (such as a television receiver), and each household has a regional characteristic. Therefore, UI control is performed in which the gaze degree of the user is estimated in units of household, and content recommendation and recommended content are presented for each household (that is, in accordance with the regional characteristics) according to the change in the gaze degree.

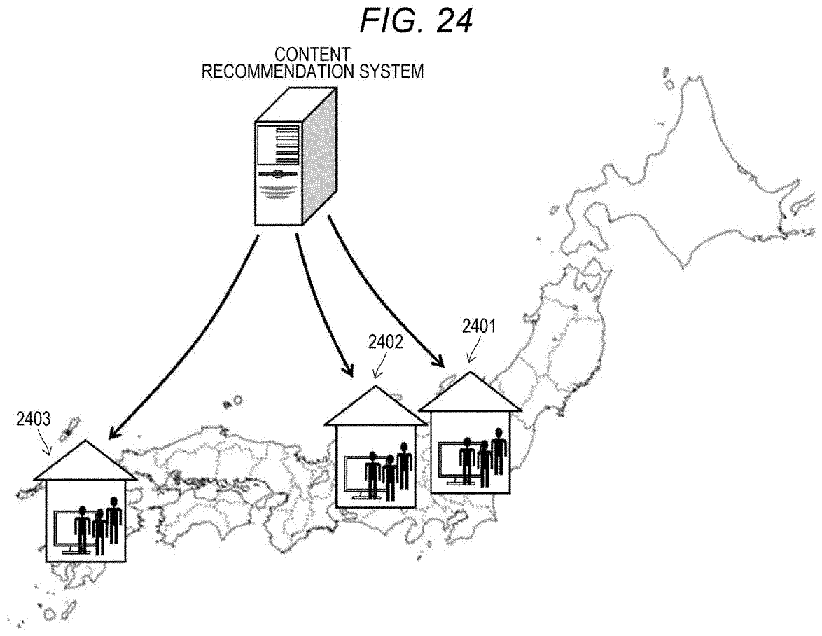

FIG. 24 shows a state in which three households 2401 to 2403 are arranged in a space.

The content reproduction apparatus 100 is arranged in each of the households 2401 to 2403, and it is assumed that a plurality of users (family members) views reproduction content together. For each household, regional characteristics such as the number of users who view reproduction content, the content of conversation, brightness, temperature, humidity, and smell are different. In FIG. 24, the household 2401 and the household 2402 are arranged relatively close to each other, and the household 2403 is arranged far away from the households 2401 and 2402, but the spatial distance does not necessarily coincide with the magnitude of the difference in regional characteristics. For example, it is also assumed that the household 2401 and the household 2403 have close regional characteristics, but the household 2401 and the household 2402 are spatially close but have greatly different regional characteristics.

Even if the same content is viewed in all households at first, when it is estimated that the content is bored in each household, the content recommendation system matches different content for each household from a difference in characteristics of each household, that is, regional characteristics. Then, a UI that recommends different content for each household is projected and displayed. Furthermore, also the timing at which the user gets bored during viewing is different from household to household, and also the timing of transitioning to a UI that recommends the content varies from household to household.

FIG. 26 shows a sequence example executed between the content reproduction apparatus 100 and the content recommendation system 2200.

The content recommendation system 2200 continuously execute deep learning of an artificial intelligence model for content recommendation processing.

On the other hand, when reproduction of content is started, that is, viewing of the content by the user is started, the content reproduction apparatus 100 executes gaze degree estimation processing of the user (SEQ 2601).

Thereafter, when estimating that the gaze degree of the user has decreased, that is, the user has been bored with the content being reproduced (SEQ 2602), the content reproduction apparatus 100 transmits viewing information and sensor information to the content recommendation system 2200, and requests the user to provide information on recommended content (SEQ 2603).

Using a deep-learned artificial intelligence model, the content recommendation system 2200 performs matching between the user and content in accordance with regional characteristics from the causal relationship between the viewing information sent from the content reproduction apparatus 100 and the sensor information including environment information, further retrieves for and acquires related information on each content on the cloud, generates control information on the UI that presents the related information on the content (SEQ 2604), and transmits the related information on the recommended content and the control information of the UI to the content reproduction apparatus 100 (SEQ 2605).

When estimating that the user has been bored with the content being viewed, the content reproduction apparatus 100 shrinks the display region of reproduction content on the screen of the image display unit 107. Then, upon receiving related information on recommended content in accordance with regional characteristics and control information of the UI from the content recommendation system 2200, the content reproduction apparatus 100 displays the related information on the recommended content in the free space obtained by shrinking the display region of the reproduction content (SEQ 2606). Furthermore, when the user selects content desired to view next through an UI operation, reproduction of the content being reproduced is stopped, and reproduction of the content selected by the user is started (SEQ 2607).

### INDUSTRIAL APPLICABILITY

The present disclosure has been described in detail above with reference to a specific embodiment. However, it is obvious that those skilled in the art can make modifications and substitutions of the embodiment without departing from the gist of the present disclosure.

In the present description, an embodiment in which the present disclosure is applied to a television receiver has been mainly described, but the gist of the present disclosure is not limited thereto. The present disclosure can be similarly applied to various types of devices that present, to the user, content acquired by streaming or downloading via a broadcast wave or the Internet, or content reproduced from a recording medium, for example, a personal computer, a smartphone, a tablet, a head-mounted display, a media player, and the like.

In short, the present disclosure has been described in the form of exemplification, and the content described in the present description should not be interpreted in a limited manner. In order to judge the gist of the present disclosure, the claims should be taken into consideration.

Note that the present disclosure can have the following configurations.

(1) An information processing apparatus including:

an estimation unit that estimates a gaze degree of a user who views content;

an acquisition unit that acquires related information to content recommended to the user; and

a control unit that controls a user interface that presents the related information on the basis of an estimation result of the gaze degree.

(2) The information processing apparatus according to (1) described above, in which

the acquisition unit acquires the related information by using an artificial intelligence model that has learned a causal relationship between information on a user and content in which a user shows interest.

(3) The information processing apparatus according to any of (1) or (2) described above, in which

information on the user includes sensor information regarding a state of a user including a line-of-sight when the user views content.

(4) The information processing apparatus according to any of (1) to (3) described above, in which

information on the user includes environment information regarding an environment when the user views content, and

the acquisition unit estimates content matching a user in accordance with a regional characteristic based on environment information for each user.

(5) The information processing apparatus according to any of (1) to (4) described above, in which

the control unit starts display of a user interface that presents the related information in response to a decrease in the gaze degree.

(6) The information processing apparatus according to any of (1) to (5) described above, in which

the control unit causes the related information to be presented by using a user interface in a form that does not hinder viewing of content by a user.

(7) The information processing apparatus according to any of (1) to (6) described above, in which

in response to a decrease in a gaze degree of the user, the control unit shrinks a display region of content being reproduced and provides a region for displaying the user interface.

(8) An information processing method including:

an estimation step of estimating a gaze degree of a user who views content;

an acquisition step of acquiring related information to content recommended to the user; and

a control step of controlling a user interface that presents the related information on the basis of an estimation result of the gaze degree.

(9) A computer program described in a computer-readable form to cause a computer to function as:

an estimation unit that estimates a gaze degree of a user who views content;

an acquisition unit that acquires related information to content recommended to the user;

a control unit that controls a user interface that presents the related information on the basis of an estimation result of the gaze degree.

### REFERENCE SIGNS LIST

100 Content reproduction apparatus
101 Demultiplexer
102 Video decoding unit
103 Audio decoding unit
104 Auxiliary data decoding unit
105 Video signal processing unit
106 Audio signal processing unit
107 Image display unit
108 Audio output unit
109 Sensor unit
120 External interface unit
150 Signal processing unit
701 Air conditioner
702, 703 Fan
704 Ceiling lighting
705 Stand light
706 Sprayer
707 Scent device
708 Chair
810 Camera unit
811 to 813 Camera
820 User state sensor unit
830 Environmental sensor unit
840 Equipment state sensor unit
850 User profile sensor unit
901 Reception unit
902 Signal processing unit
903 Output unit
904 Sensor unit
905 Gaze degree estimation unit
906 Buffer unit
907 Viewing information acquisition unit
908 Transmission unit
1000 Artificial intelligence server
1001 Database for learning data
1002 Neural network (for content recommendation processing)
1003 Evaluation unit
1101 Reception unit
1102 Signal processing unit
1103 Output unit
1104 Sensor unit
1105 Gaze degree estimation unit
1106 UI control unit
1107 Information request unit
1108 Transmission unit
1800 Content recommendation system
1801 Reception unit
1802 Recommended content estimation unit
1803 Content-related information acquisition unit
1804 Related information acquisition control unit
1805 Transmission unit
1901 Reception unit
1902 Signal processing unit
1903 Output unit
1904 Sensor unit
1905 Gaze degree estimation unit
1906 Buffer unit
1907 Viewing information acquisition unit
1908 Transmission unit
1909 Filter
2000 Artificial intelligence server
2001 Database for learning data
2002 Neural network (for content recommendation processing)
2003 Evaluation unit
2101 Reception unit
2102 Signal processing unit
2103 Output unit
2104 Sensor unit
2105 Gaze degree estimation unit
2106 UI control unit
2107 Information request unit
2108 Transmission unit
2109 Filter
2200 Content recommendation system
2201 Reception unit
2202 Recommended content estimation unit
2203 Content-related information acquisition unit
2204 Related information acquisition control unit
2205 Transmission unit

1. An information processing apparatus comprising:
an estimation unit that estimates a gaze degree of a user who views content;
an acquisition unit that acquires related information to content recommended to the user; and
a control unit that controls a user interface that presents the related information on a basis of an estimation result of the gaze degree.

2. The information processing apparatus according to claim 1, wherein
the acquisition unit acquires the related information by using an artificial intelligence model that has learned a causal relationship between information on a user and content in which a user shows interest.

3. The information processing apparatus according to claim 1, wherein
information on the user includes sensor information regarding a state of a user including a line-of-sight when the user views content.

4. The information processing apparatus according to claim 1, wherein
information on the user includes environment information regarding an environment when the user views content, and
the acquisition unit estimates content matching a user in accordance with a regional characteristic based on environment information for each user.

5. The information processing apparatus according to claim 1, wherein
the control unit starts display of a user interface that presents the related information in response to a decrease in the gaze degree.

6. The information processing apparatus according to claim 1, wherein
the control unit causes the related information to be presented by using a user interface in a form that does not hinder viewing of content by a user.

7. The information processing apparatus according to claim 1, wherein
in response to a decrease in a gaze degree of the user, the control unit shrinks a display region of content being reproduced and provides a region for displaying the user interface.

8. An information processing method comprising:
an estimation step of estimating a gaze degree of a user who views content;
an acquisition step of acquiring related information to content recommended to the user; and
a control step of controlling a user interface that presents the related information on a basis of an estimation result of the gaze degree.

9. A computer program described in a computer-readable form to cause a computer to function as:
an estimation unit that estimates a gaze degree of a user who views content;
an acquisition unit that acquires related information to content recommended to the user;
a control unit that controls a user interface that presents the related information on a basis of an estimation result of the gaze degree.
